(19) United States
(12) Patent Application Publication
(10) Pub. No.: US 2009/0067854 A1
(43) Pub. Date: Mar. 12, 2009

(54) OPTICAL SPACE COMMUNICATION RECEPTION CIRCUIT, OPTICAL SPACE COMMUNICATION DEVICE, OPTICAL SPACE COMMUNICATION SYSTEM, AND ELECTRONIC DEVICE

(76) Inventors: Naruichi YOKOGAWA, Kashihara-shi (JP); Takeshi Nishino, Kidugawa-shi (JP); Hitoshi Naoe, Kitakatsuragi-gun (JP)

Correspondence Address: BIRCH STEWART KOLASCH & BIRCH, PO BOX 747, FALLS CHURCH, VA, 22040-0747, US

(21) Appl. No.: 12/129,493

(22) Filed: May 29, 2008

(30) Foreign Application Priority Data
May 31, 2007 (JP) 2007-146189

(51) Int. Cl. H04B 10/06

(52) U.S. Cl. 398/202

(57) ABSTRACT

An optical space communication reception circuit receives a signal in switched-over communication speed modes and under settings corresponding to the communication speed modes. Receiver sensitivity in the respective communication speed modes is set in advance such that maximum communicable distances in the communication speed modes are substantially equal. By this, it becomes possible, for example, in optical space transmission such as infrared communication and the like to enhance a false operation prevention characteristic against disturbance noise, without decreasing maximum communicable distances.

This Nonprovisional application claims priority under 35 U.S.C. § 119(a) on Patent Application No. filed in Japan on May 31, 2007, the entire contents of which are hereby incorporated by reference.

### FIELD OF THE INVENTION

The present invention relates to an optical space communication reception circuit, an optical space communication device, an optical space communication system, and an electronic device, and more particularly relates to art of reducing influence of disturbance noise in infrared communication.

### BACKGROUND OF THE INVENTION

Optical space communication has become common due to adoption of infrared communication in portable phones or the like in recent years. The optical space communication is described below with reference to an embodiment in accordance with IrDA, a general code and standard for the infrared communication.

FIG. 13 is a diagram schematically showing a configuration of a general infrared communication system. FIG. 13 shows a configuration where an infrared communication devices 500A and 500B exchange an infrared signal (a light signal) with each other in optical space communication.

The infrared communication device 500A is an electronic device such as, for example, a portable phone, a game console, and the like, that includes an infrared communication function of exchanging data by the infrared signals. The infrared communication device 500A includes: an infrared communication transmission reception device 501A that transmits data to the infrared communication device 500B or receives data therefrom; and a communication controller 502A that controls a transmission and reception state of the infrared communication transmission device 501A. The rest parts of the infrared communication device 500A, which are omitted in FIG. 13, are also included in general conventional configurations.

FIG. 14 is a block diagram of a circuit, showing an internal configuration of the infrared communication transmission reception device 501A. As shown in FIG. 14, the infrared communication transmission reception device 501A includes a transmission circuit 650 for transmitting a light signal and a reception circuit 600 for receiving a light signal.

The transmission circuit 650 includes a light emitting diode (LED) for outputting the light signal, a signal input terminal TX for receiving a pulse signal, a control logic circuit (Cnt_logic) 651 for outputting a control signal based on the pulse signal inputted from the signal input terminal TX, and a driver 652 for operating the light emitting diode LED based on the control signal outputted from the control logic circuit 651.

A reception circuit 600 includes: a photo diode (PD) for outputting the received light signal as a current signal; a first amplifier (Amp 1) 601 for converting, into a voltage signal, the current signal outputted from the photo diode; a second amplifier (Amp 2) 602 for amplifying the voltage signal outputted from the first amplifier 601; a hysteresis comparator circuit 603 for comparing a voltage signalₐₘₚ_{_{—}}ₒᵤₜ outputted from the second amplifier 602 with a threshold value and then outputting a pulse signal_{comp out}; a one shot pulse generation circuit (One_shot) 604 for outputting a pulse signal_{OS out} based on the pulse signal_{Comp out} outputted from the hysteresis comparator circuit 603; an inverter 605 for inverting and outputting the pulse signal_{OS out} outputted from the one shot pulse generation circuit 604; and a signal output terminal RX for outputting the pulse signal outputted from the inverter 605.

That is to say, the infrared communication transmission reception device 501A inputs a pulse signal (electric signal) carrying transmission data outputted from the transmission signal output terminal TXD of the communication controller 502A which is provided at the signal input terminal TX, and transmits it, by the transmission circuit 650, as a light signal to the infrared communication device 500B. Besides, the infrared communication transmission reception device 501A receives the light signal transmitted from the infrared communication device 500B, and outputs, from the signal output terminal RX to a received signal input terminal RXD of the transmission controller 502A, a pulse signal, the signal converted at the reception circuit 600 and carrying the received data (electric signal). By this, the infrared communication device 500A can perform infrared communication with the infrared communication device 500B.

The infrared communication device 500B has an identical configuration as the infrared communication device 500A. That is to say, the transmission reception device 501B has an identical configuration as the infrared communication transmission reception device 501A while the communication controller 502B has an identical configuration as the communication controller 502A. For easy explanation, the infrared communication transmission reception device 501A is referred to as a Device A and the infrared communication transmission reception device 501B is referred to as a Device B.

Here, a maximum communicable distance between the Device A and B is determined by a relation between a transmission output (transmission intensity) and receiver sensitivity of the Device A and B. The following description first deals with the transmission output and the receiver sensitivity, and then deals with the maximum communicable distance.

In order to maintain maximum communicable distances, the IrDA sets, as shown in table 1, a code and standard for the transmission output between the infrared communication transmission reception devices while setting, as shown in FIG. 2, a code and standard of the receiver sensitivity between the infrared communication transmission reception devices.

TABLE 1

| | Electricity | | | |
|---|---|---|---|---|
| Communication | Consumption | Minimum | | Maximum |
| speed | Option | Value | | Value |
| 115 kbps or | Standard Power | 40 | mW/sr | 500 mW/sr |
| Below | Low Power | 3.6 | mW/sr | 500 mW/sr |
| Above 115 kbps | Standard Speed | 100 | mW/sr | 500 mW/sr |
| | Low Speed | 9 | mW/sr | 500 mW/sr |

TABLE 2

| | Electricity | | | |
|---|---|---|---|---|
| Communication | Consumption | Minimum | | Maximum |
| speed | Option | Value | | Value |
| 115 kbps or | Standard | 4 | μW/cm² | 500 mW/cm² |
| Below | Power | | | |
| | Low Power | 9 | μW/cm² | 500 mW/cm² |
| Above 115 kbps | Standard | 10 | μW/cm² | 500 mW/cm² |
| | Speed | | | |
| | Low Speed | 22.5 | μW/cm² | 500 mW/cm² |

FIG. 15 shows an exemplary combination between transmission output and receiver sensitivity of an infrared communication transmission device. HS stands for a high speed (here, the high speed is set above 115 kbps); LS stands for a low speed (here, the low speed is set below or equal to 115 kbps); SP stands for a standard power, LP stands for a low power; TX stands for a transmission side; and RX stands for a reception side.

For example, Type 1 of the exemplary combinations supports two communication speeds (high speed and low speed). Of a case of the high speed communication, a minimum value of the transmission output (100 mW/sr) and a minimum value of the receiver sensitivity (10 μW/cm²) are set. Also, of a case of low speed communication, a minimum value of the transmission output (40 mW/sr) and a minimum value of the receiver sensitivity (4 μW/cm²) are set. As described above, each of the exemplary combinations complies with the IrDA code and standard by maintaining an minimum output value and a minimum receiver sensitivity described in the column “Minimum Output Value or Minimum Receiver Sensitivity.

Here, the infrared communication transmission reception device, which supports the plurality of communication speeds, is provided with switching means for optimizing a communication speed mode for the respective communication speeds. The Device A and B shown in FIG. 13 include a mode switch terminal MODE for switching over the communication speed modes, and the communication speed modes are switched by control signals outputted from control signal output terminals MODE of the communication controllers 502A and 502B.

Besides, particularly, the reception circuit 600 including the infrared communication transmission reception device significantly changes its capability according to a setting condition; therefore, a circuit condition requires to be set up for respective communication speed modes. Thus, with reference to FIGS. 16 to 18, the following description explains a configuration of the reception circuit 600, which sets up the circuit condition for the respective communication speed modes, and with a function of the configuration.

FIG. 16 is a block diagram of an equivalent circuit, showing a configuration of a reception circuit 600 provided with the switching means. FIG. 16 omits a circuit disposed downstream to a hysteresis comparator circuit 603 while showing a voltage output terminal VO connected to an output side of the hysteresis comparator 603. That is to say, the voltage output terminal VO is connected to an input side of a one shot pulse generation circuit 604 shown in FIG. 14.

In the reception circuit 600, a control signal outputted from a communication controller 502A (communication controller 502B) connected to the reception circuit is transmitted to a second amplifier 602 via a mode switch terminal MODE. By this, the communication speed mode is set up, with frequency characteristics of the second amplifier 602 being switched over. Thus, the circuit condition is set up for the respective communication speed modes in the reception circuit 600.

FIG. 17 is a block diagram of an equivalent circuit, showing another configuration of the reception circuit 600 provided with the switching means.

As shown in FIG. 17, a reception circuit 600 includes, in addition to the configuration shown in FIG. 16, an automatic gain control circuit (AGC) 611 for automatically controlling gains of a first amplifier 601 and a second amplifier 602 according to a voltage signal_{amp out} outputted from the second amplifier 602.

By this, the reception circuit 600 sets communication speed mode by switching over frequency characteristics of the second amplifier 602. Also, the reception circuit 600 sets a circuit condition more suitably for the respective communication speed mode by switching over gains of the first amplifier 601 and the second amplifier 602.

Besides, FIG. 18 shows relations between gains and frequency characteristics in the reception circuits 600 as shown in FIGS. 16 and 17, which switch over the communication speed modes. The vertical axis shows relative amplitude (gain) and the horizontal axis shows a frequency (Hz). Besides, a bold line shows the LS mode, a continuous line shows the HS mode, and a dashed line shows the disturbance noise generated outside of the reception circuit 600.

With reference to the examples of the IrDA code and standard, it is described that high gains are set in a relatively low frequency range in a communication speed mode less than or equal to the communication speed of 115 kbps (hereafter, referred to as an LS mode), as FIG. 18 shows. On the other hand, low gains are set in a relatively high frequency range in the communication speed mode greater than the communication speed of 115 kbps (hereafter, referred to as an HS mode). In detail, gains as large as 0.4 times than gains in the LS mode are set in the HS mode. This is because receiver sensitivity as large as 0.4 times than receiver sensitivity in the LS mode is set up as a standard value, as Table 2 shows.

Therefore, the reception circuit 600 has the communication speed modes of the HS mode and the LS mode. The communication speed mode is set up, as the receiver sensitivity adjusted to the HS mode and the receiver sensitivity adjusted to the LS mode, which are shown in FIG. 18, are switched over alternately by controlling signals inputted in the mode switch terminal MODE.

Then, the following description deals with a maximum communicable distance between the infrared communication transmission reception devices, with reference to the various types of infrared communication transmission reception devices shown in FIG. 15.

For example, with reference to FIG. 13, it is found that in a case of two-way communication, the maximum communicable distance between the Devices A and B is determined by a shorter maximum communicable distance between (i) the distance determined by the transmission output of the Device A and the receiver sensitivity of the Device B and (ii) the distance determined by the transmission output of the Device B and the receiver sensitivity of the Device A. For simplicity, the following description deals with one-way communication in which signals are transmitted from the Device A and received by the Device B.

FIG. 19 shows exemplary combinations of the transmission outputs of the Device A, which is a transmission side, and exemplary combinations of the receiver sensitivities of the Device B, which is a reception side.

FIG. 20 shows a list of the maximum communicable distances extracted from the exemplary combinations shown in FIG. 19. FIG. 20 extracts every combination pattern between the TYPE TX1 and the TYPES RX 1 to RX4 shown in FIG. 19, wherein the TYPE TX1 is for the Device A of the transmission side and the TYPES RX1 to RX4 are for the Device B of the reception side. Also, FIG. 20 extracts every combination pattern between the TYPE TX4x and the TYPES RX1 to RX4 in FIG. 19, wherein the TYPE TX4x is for the Device A of the transmission side and the TYPES RX1 to RX4 are for the Device B of the reception side.

The maximum communicable distances are calculated by the following equation.

$$\sqrt{\frac{transmission output of Device A ( mW \text{/} sr \times 1000 )}{reveiver sensitivity of Device B ( u W \text{/} {cm}^{2} )}} ( cm ) \qquad ( Equation 1 )$$

However, if the gains of the amplifiers of the internal reception circuit (for example, the first amplifier 601 and the second amplifier 602 of the reception circuit 600 shown in FIGS. 16 and 17) vary due to variances (unevenness) in characteristics caused during manufacturing processes, the receiver sensitivities do not stay constant, and variances in actual communicable distances increase.

In approaching to this issue, the reception circuit 600 having the automatic gain control circuit 611 that automatically controls gains of the amplifier 601 and the second amplifier 602 based on the voltage signal_{amp out} outputted from the second amplifier 602 is effective, as shown in FIG. 17.

On the other hand, for example, Japanese Unexamined Patent Application Publication, Tokukai-hei 9-83272 (published on Mar. 28, 1997) discloses art of controlling receiver sensitivity through a process of detecting noise magnitude in a demodulating circuit at a time of signal demodulation, and then automatically adjusting, based on detection output, a gain of an amplifier disposed upstream to the demodulating circuit.

However, there is a problem that a communicable distance gets shortened if the receiver sensitivity is lowered by setting the gain lower so as to prevent false reception by noise.

In response to this problem, for example, Japanese Unexamined Patent Application Publication Tokukai-hei 10-233737 (published on Sep. 2, 1998) discloses art of preventing the false reception by noise through a process of checking, at an early stage, whether a received signal is a normal communication signal, and (i) raising receiver sensitivity if the signal is the normal communication signal or (ii) not processing the received signal as communication data if the signal is not the normal communication signal.

By the way, referring to the maximum communicable distances shown in FIG. 20, it is obvious that maximum communicable distances, which are determined by the transmission outputs of the Device A and the receiver sensitivities of the Device B, differ between the communication speed modes. That is to say, when communication is made between the devices complying with the IrDA code and standard, maximum communicable distances vary between the communication speeds. Therefore, performance level is limited by the shorter one of the maximum communicable distances.

For example, in a case of the combination 1 shown in FIG. 20 (the combination between TYPE TX1 and TYPE RX1), the maximum communicable distance of the LS mode is 158 cm while the maximum communicable distance of the HS mode is 100 cm. In this case, the maximum communicable distance between the Device A and the Device B is 100 cm, which equals to the shorter one of the maximum communicable distances.

Thus, even though the maximum communicable distance between the Device A and the Device B is limited by the maximum communicable distance of the HS mode, the LS mode has the receiver sensitivity capable of communicating in a longer distance. That is to say, the receiver sensitivity of the LS mode is unnecessarily high. By this, since the receiver sensitivity is unnecessarily high, it is easier to receive unwanted noise.

An infrared wavelength used in the IrDA is a wavelength between 850 nm to 900 nm. On the other hand, in a case that electronic device is a portable phone for example, the portable phone includes a fluorescence light, a backlight of an LCD display, and the like in addition to the infrared communication transmission reception device. Disturbance noise of the fluorescence light, backlight of the LCD display, and the like emit infrared radiations, wavelengths of which are close to the range of the infrared wavelength used in the IrDA; therefore, the disturbance noise arises in a frequency range overlapping with the frequency range of the LS mode shown in FIG. 18.

Therefore, the infrared communication transmission reception device involves a problem that influenced by infrared noise, the device is likely to perform false operation within the range of the wavelengths close to the wavelength used for the optical space transmission, that is to say the device is likely to perform false operation particularly when the communication speed mode is the LS mode.

Furthermore, besides having the close wavelengths, disturbance noise also has an electric modulation frequency in a range which is likely to interfere with the IrDA communication. FIG. 21 shows images of electric frequency spectrums of the infrared signals and noise. The vertical axis shows relative amplitude and the horizontal axis shows a frequency (Hz). In addition, frequency spectrums of 2.4 kbps to 115.2 kbps, 1.152 Mbps, 4 Mbps and 16 Mbps are shown with continuous lines while the disturbance noise is shown with a dashed line. Referring to FIG. 21, it becomes obvious that electric frequency spectrums of the infrared signals and noise overlap with each other.

### SUMMARY OF THE INVENTION

The present invention is made in the view of the problems, and an object of the present invention is to provide an optical space communication reception circuit, an optical space communication device, an optical space communication system, and an electronic device, each of which improves, without shortening a maximum communicable distance, a false operation prevention characteristic against noise in optical space communication such as infrared communication, for example.

In order to attain the object, an optical space communication reception circuit according to the present invention receives a signal in switched-over communication speed modes and under settings respectively corresponding to the communication speed modes, wherein receiver sensitivity in the respective communication speed modes is set in advance such that maximum communicable distances in the communication speed modes are substantially equal.

In a case that a plurality of the communication speed modes are provided, maximum communicable distances of the optical space communication reception circuit are limited by the minimum value of the maximum communicable distances in the communication speed modes. Therefore, any communication speed mode having maximum communicable distance longer than the minimum value has unnecessarily high receiver sensitivity.

Thus, according to the above configuration, the receiver sensitivities in the plurality of the communication speed modes are set in advance such that maximum communicable distances in the communication speed modes are substantially equal. Consequently, receiver sensitivity of the communication speed mode having the maximum communicable distance longer than the minimum value is set lower such that the maximum communicable value is set at the minimum value.

Therefore, since it is avoided that a communication speed mode has the unnecessarily high receiver sensitivity, it is possible to make the unwanted false operations less likely to occur by reducing the influence of the unwanted noise such as disturbance noise, electric noise, and the like. Consequently, it becomes possible to enhance the false operation prevention characteristics against noise, without shortening the maximum communicable distances.

Besides, the optical space communication reception circuit according to the present invention for receiving a signal in switched-over communication speed modes and under settings respectively corresponding to the communication speed modes includes the receiver sensitivity adjustment circuit for adjusting receiver sensitivity in the respective communication speed modes such that maximum communicable distances in the communication speed modes are substantially equal.

In a case that the plurality of communication speed modes are provided, maximum communicable distances of the optical space communication reception circuit are limited by minimum values of maximum communicable distances in the communication speed modes. Thus, any communication speed mode having the maximum communicable distance longer than the minimum value has unnecessarily high receiver sensitivity.

Therefore, according to the above configuration, since the receiver sensitivity adjustment circuit is provided, the circuit adjusting receiver sensitivities in the plurality of the communication speed modes such that maximum communicable distances in the communication speed modes are substantially equal, receiver sensitivities of communication speed modes having maximum communicable distances longer than minimum values are set lower such that the maximum communicable distances are set up at the minimum value.

Therefore, it is avoided that a communication speed mode has the unnecessary high receiver sensitivity, thereby it is possible to make the unwanted false operation less likely to occur by reducing the influence of unwanted noise such as disturbance noise, electrical noise, and the like. Thus, it is possible to enhance false operation prevention characteristics against noise, without shortening maximum communicable distances.

Furthermore, the optical space communication reception circuit according to the present invention for receiving a signal in switched-over communication speed modes and under settings respectively corresponding to the communication speed modes includes the receiver sensitivity adjustment circuit which, if the signal cannot be received due to noise input, switches over to receiver sensitivity for a communication speed mode selected subsequently to a communication speed mode used when noise is inputted or switches a setting of the optical space communication reception circuit to a circuit condition corresponding to a communication speed for the communication speed mode selected subsequently.

When noise is inputted, there may be a case that a signal cannot be received properly, and a communication speed mode used at the time of the noise input does not end properly. In this case, communication is disrupted arbitrarily.

On the other hand, according to the configuration above, since the receiver sensitivity adjustment circuit is provided, the optical space communication reception circuit either (i) switches over to the receiver sensitivity in the communication speed mode picked subsequently to the communication mode used when noise is inputted or (ii) switches the setting to the circuit condition corresponding to the communication speed for the communication speed mode picked subsequently, if a signal cannot be received due to the noise being inputted. Therefore, it is possible to cancel the communication speed mode used when noise is inputted and then to switch over to the communication speed mode to be picked subsequently. Consequently, it is possible to prevent communication from being disrupted, which thereby makes it possible to make the unwanted false operation less likely to occur. Thus, it is possible to enhance the false operation prevention characteristics against noise, without shortening the maximum communicable distances.

Besides, the optical space communication device according to the present invention includes the optical space communication reception circuit which includes a light receiving element for receiving a sent light signal in switched-over communication speed modes under settings respectively corresponding to the communication speed modes and an optical space communication transmission circuit which includes a light emitting element for outputting a light signal,

According to the above configuration, it is possible, by providing the optical space communication reception circuit capable of enhancing the false operation prevention characteristics against noise, to provide the optical space communication device having high false operation prevention characteristics against noise and having a transmission reception function.

In addition, the optical space communication system according to the present invention includes the optical space communication device.

According to the above configuration, it is possible to provide the optical space communication system which excels in false operation prevention capability against noise and reduces generation of the communication disruption by the false operation.

Furthermore, the optical space communication system of the present invention, the system includes the optical space communication reception circuit which receives signals under the settings respectively corresponding to the plurality of communication speed modes to be switched over, includes a receiver sensitivity adjustment circuit which, in a case that inputted noise interferes with reception of the signals, either (i) switches over to receiver sensitivity in a communication speed mode picked subsequently to a communication speed mode used when noise is inputted or (ii) switches a setting to a circuit condition corresponding to communication speed for the communication speed mode picked subsequently.

When noise is inputted in the optical space communication reception circuit, there may be a case that a signal cannot be received properly, and a communication speed mode used at the time of the noise input does not end properly. In this case, communication is disrupted arbitrarily.

On the other hand, according to the above configuration, provided with the receiver sensitivity adjustment circuit, the optical space communication reception circuit (i) switches over to the receiver sensitivity in the communication speed mode picked subsequently to the communication speed mode used when noise is inputted or (ii) switches the setting to the circuit condition corresponding to the communication speed for the communication speed mode picked subsequently, if the noise input interferes with the reception of signals. Consequently, it is possible to cancel the communication speed mode used at the time of the noise input and then to switch over to the communication speed mode picked subsequently. Thus, it is possible to make the unwanted false operation less likely to occur by preventing the communication disruption. This thereby makes it possible to provide the optical space communication system reducing the generation of the communication disruption by the false operation.

In addition, an electronic device according to the present invention includes the optical space communication device.

According to the above configuration, it is possible to provide the electronic device where the false operation is less likely to occur, while noise influence generated in the device is reduced.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram of a circuit, showing an embodiment of the optical space communication reception circuit of the present invention.

FIG. 2 is a waveform chart showing the switching of the communication speed modes in the optical space communication reception circuit.

FIG. 3 is a table showing exemplary settings of the receiver sensitivity in the optical space communication reception circuit.

FIG. 4 is a graph showing exemplary gain frequency characteristics in the optical space communication reception circuit.

FIG. 5 is a block diagram of a circuit, showing another embodiment of the optical space communication reception circuit of the present invention.

FIG. 6 is a graph showing exemplary gain frequency characteristics in the optical space communication reception circuit.

FIG. 7 is a graph showing other exemplary gain frequency characteristics in the optical space communication reception circuit.

FIG. 8 is a block diagram of a circuit, showing yet another embodiment of the optical space communication reception circuit of the present invention.

FIG. 9 is a waveform chart showing pulse parameters for the communication speeds in the IrDA code and standard.

FIG. 10 is a block diagram of a circuit, showing another configuration of the noise detection circuit of the optical space communication reception circuit.

FIG. 11 is a block diagram of a circuit, showing yet another configuration of the noise detection circuit of the optical space communication reception circuit.

FIG. 12 is a block diagram of a circuit, showing still another embodiment of the optical space communication reception circuit of the present invention.

FIG. 13 is a view, schematically showing a general infrared communication system.

FIG. 14 is a block diagram of an equivalent circuit, showing an internal configuration of a conventional infrared communication transmission reception device.

FIG. 15 is a table showing transmission outputs and receiver sensitivities of conventional infrared communication transmission reception device.

FIG. 16 is a block diagram of an equivalent circuit, showing a configuration of the conventional reception circuit provided with the switching means.

FIG. 17 is a block diagram of an equivalent circuit, showing another configuration of the conventional reception circuit provided with the switching means.

FIG. 18 is a graph showing gain frequency characteristics in conventional reception circuits.

FIG. 19 is a table showing exemplary transmission output types and exemplary receiver sensitivity types in conventional infrared communication transmission reception device.

FIG. 20 is a table showing maximum communicable distances in the combinations extracted from the exemplary types shown in FIG. 19.

FIG. 21 is a graph showing exemplary electrical spectrums of infrared communication and noise.

### DESCRIPTION OF THE EMBODIMENTS

### First Embodiment

One embodiment of the present invention is described below with reference to drawings.

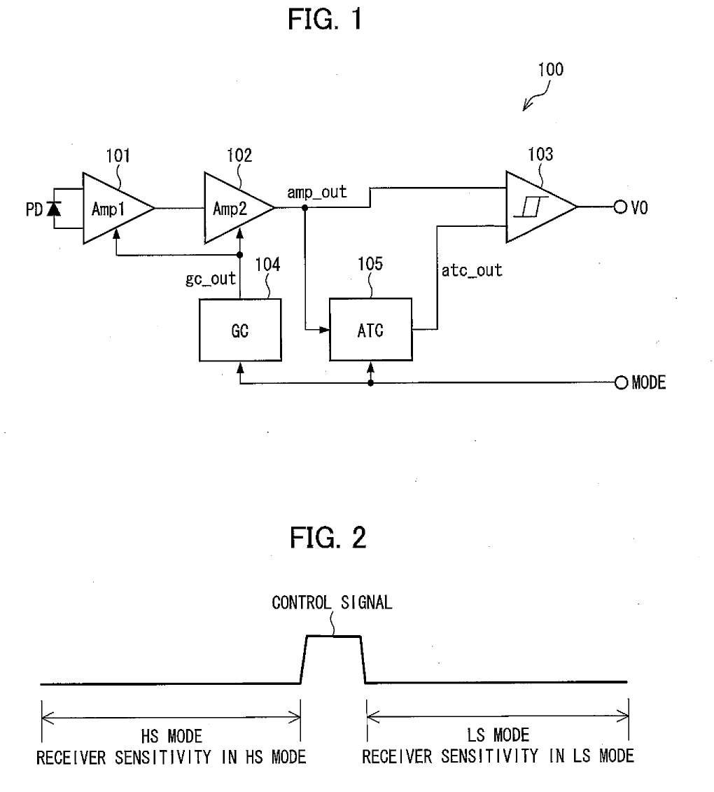

FIG. 1 is a block diagram of an equivalent circuit, showing an exemplary configuration of an optical space communication reception circuit 100 of the present embodiment.

As show in FIG. 1, the optical space communication reception circuit 100 of the present embodiment includes: a photo diode for outputting a received light signal as a current signal; a first amplifier (Amp 1) 101 for converting, into a voltage signal, the current signal outputted from the photo diode; a second amplifier (Amp 2) 102 for amplifying the voltage signal outputted from the first amplifier 101; a hysteresis comparator circuit 103 for comparing a voltage signal_{amp out} outputted from the second amplifier 102 with a threshold value_{atc out} and outputting a pulse signal; a voltage output terminal (VO) connected to an output side of the hysteresis comparator circuit 103; a mode switch terminal (MODE) for receiving a control signal; a gain control circuit (GC) 104 for controlling gains of the first amplifier 101 and the second amplifier 102 based on the control signal inputted from the mode switch terminal; and a threshold control circuit (ATC) 105 that provides the threshold value_{atc out} of the hysteresis comparator circuit 103, while controlling it based on the voltage signal_{amp out} outputted from the second amplifier 102 and on the control signal inputted from the mode switch terminal.

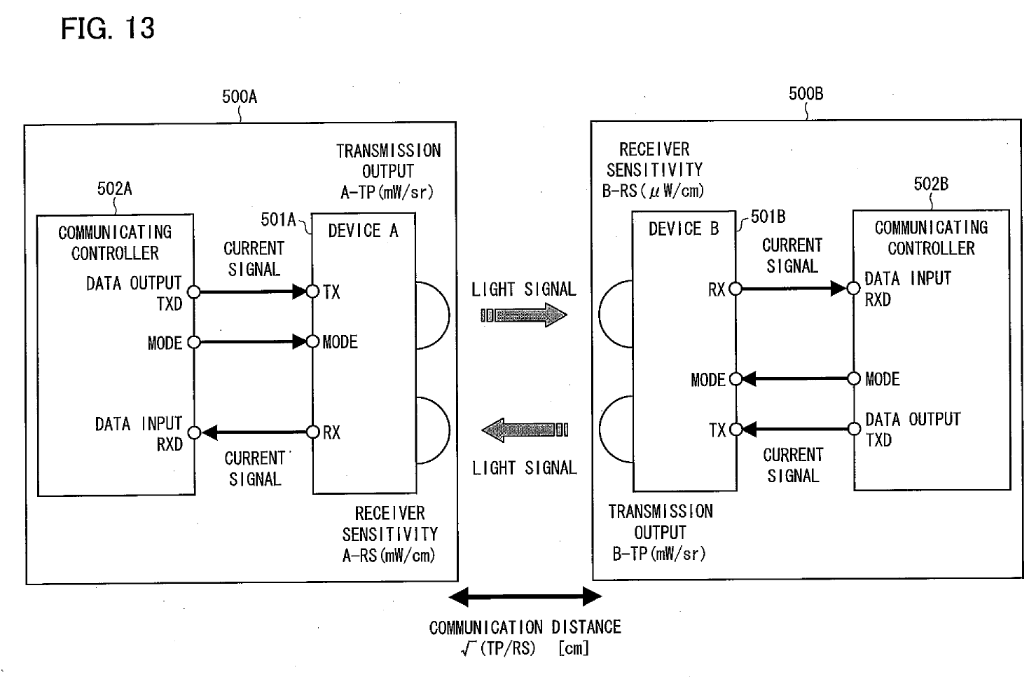

Besides, the optical space communication reception circuit 100 of the present embodiment is provided at a part of a Device A (Device B) which receives a transmission signal, wherein an infrared communication device 500A (500B) includes, as shown in FIG. 13 for example: a communication controller 502A (502B) for controlling transmission and reception operation; and an infrared communication transmission reception device 501A (501B) (Device A (Device B)) for performing transmission and reception of communication signals, based on the controlling by the communication controller 502A (502B).

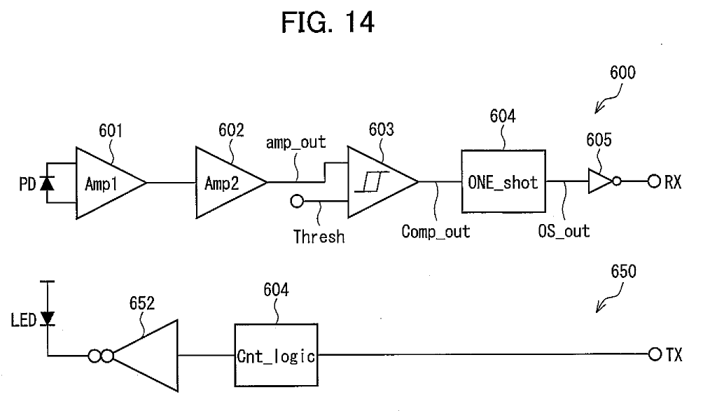

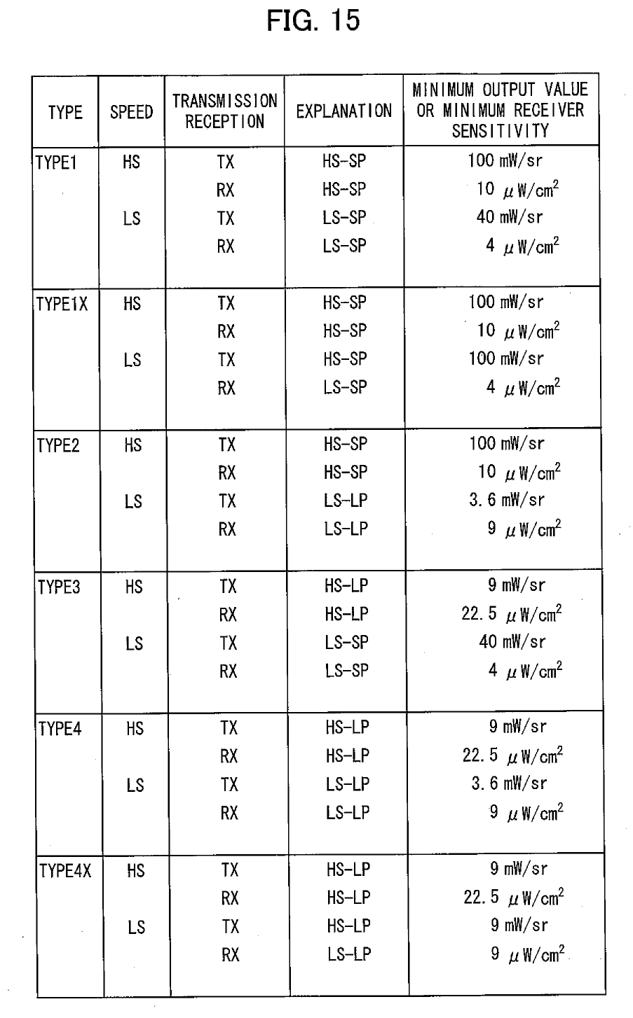

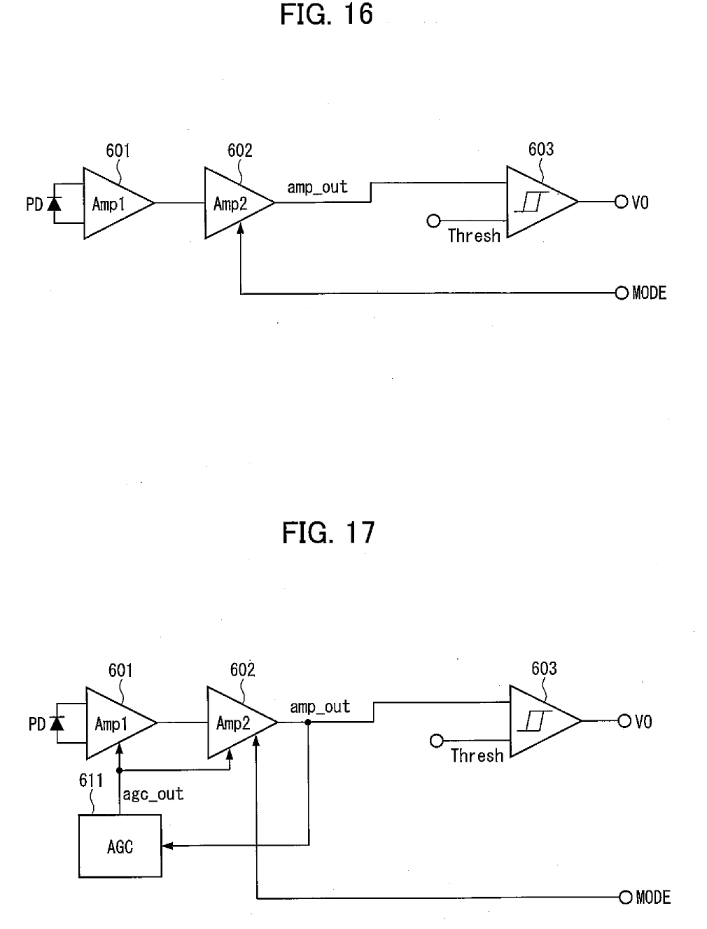

That is to say, the voltage output terminal is connected to an input side of a one shot pulse generation circuit 604 shown in FIG. 14, and received signals are transmitted, to a received signal input terminal RXD of the communication controller 502A, from a signal output terminal RX shown in FIG. 14, that is, a signal output terminal RX of the Device A shown in FIG. 13.

Furthermore, the optical space communication reception circuit 100 of the preset embodiment includes an HS mode (a communication speed mode having a communication speed above 115 kbps) and an LS mode (a communication speed mode having a communication speed below or equal to 115 kbps), which support different communication speeds. As shown in FIG. 2, in the optical space communication reception circuit 100, the HS mode and the LS mode are switched over by a control signal outputted from the control signal output terminal MODE of the communication controller 502A. FIG. 2 illustrates switching from the HS mode to the LS mode) yet the HS mode and the LS mode are switched over alternately such that a switching continues from the HS mode, to the LS mode, the HS mode, the LS mode, and so on.

In detail, the gain control circuit 104 switches between gain controlling for the high speed communication and gain controlling for low speed communication, in accordance with a control signal inputted from the mode switch terminal (MODE). (The gain controlling for the high speed communication and gain controlling for the low speed communication are set in advance.) Meanwhile, the threshold control circuit 105 switches between threshold controlling for the high speed communication and threshold controlling for the low communication speed according to the control signal. (The threshold control for the high speed communication and the threshold controlling for the low speed communication are set in advance.)

By this, gain controlling and threshold controlling are performed, and thereby the receiver sensitivity of the optical space communication reception circuit 100 is controlled based on communication speeds. That is to say, the receiver sensitivity corresponding to the high speed communication is set up when the gain controlling and the threshold controlling corresponding to the high speed communication are performed while the receiver sensitivity corresponding to the low speed communication is set up when the gain controlling and the threshold controlling corresponding to the low speed communication are performed.

Thus, a condition, where the receiver sensitivity for the high speed communication is set up, becomes the HS mode and a condition, where the receiver sensitivity for the low speed communication is set up, becomes the LS mode. Therefore, the HS mode and the LS mode can be switched between by the control signal.

Next, the following specifically describes the receiver sensitivities set in the HS mode and the LS mode.

Maximum communicable distances between the infrared communication transmission reception devices that satisfy the transmission output and the receiver sensitivity stipulated by the IrDA code and standard, include 4 types (1 to 4) of maximum communicable distances described below, according to combinations by the transmission outputs and the receiver sensitivities between the infrared communication transmission reception devices.

(1) a maximum communicable distance determined by transmission output of the Device A and receiver sensitivity of the Device B for high speed communication;

(2) a maximum communicable distance determined by transmission output of the Device B and receiver sensitivity of the Device A for high speed communication;

(3) a maximum communicable distance determined by transmission output of the Device A and receiver sensitivity of the Device B for low speed communication;

(4) a maximum communicable distance determined by transmission output of the Device B and receiver sensitivity of the Device A for low speed communication. Here, for easy explanation, a case of one-way communication is described. That is to say, the case where signals are transmitted from the Device A to the Device B is described. In this case, there are two types of maximum communicable distances, which are the maximum communicable distances (1) and (3) above.

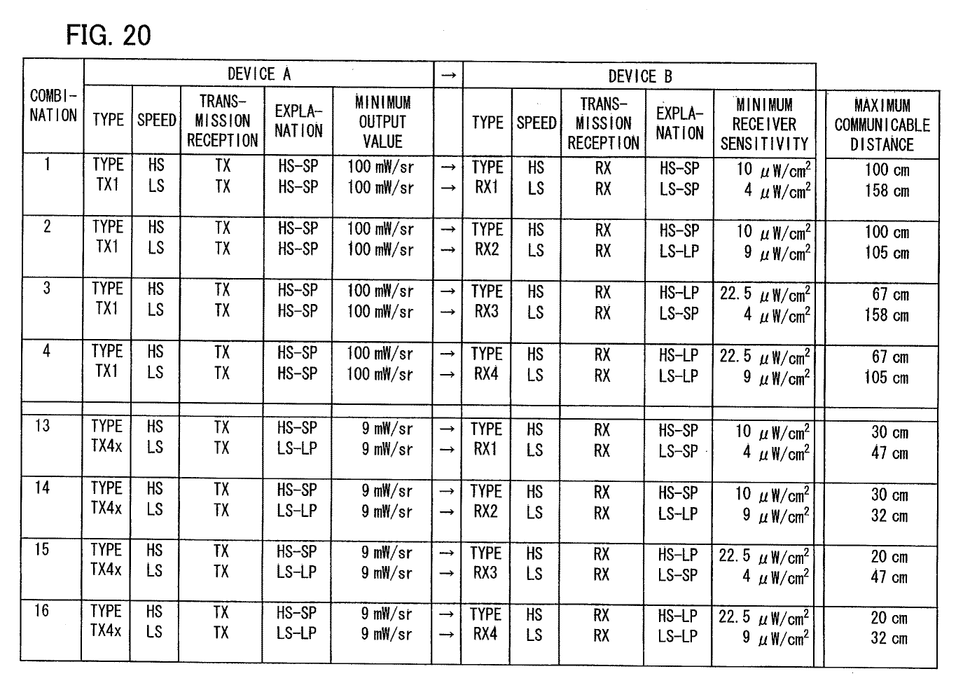

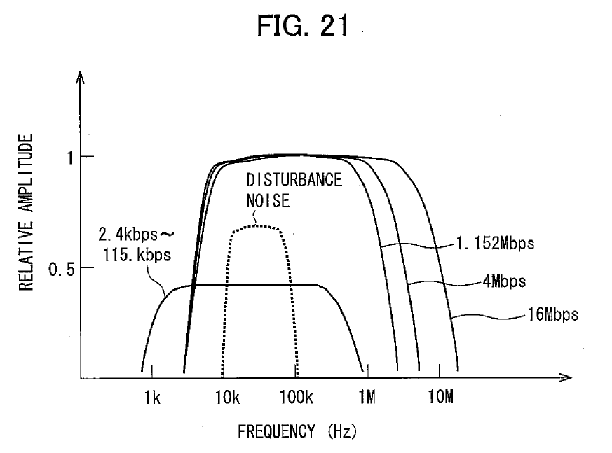

For example, values of the maximum communicable distances (1) and (3) are 100 cm (1) and 158 cm (3) respectively in the Combination 1 of FIG. 20. As described above, if the maximum communicable distances (1) and (3) are different, the maximum communicable distance between the Device A and the Device B is limited by the smaller one of the maximum communicable distances (1) and (3). Thus, the maximum communicable distance between the Device A and the Device B is 100 cm.

In the exemplary combinations between the Device A of the transmission side and the Device B of the reception side shown in FIG. 20, the maximum communicable distances of the HS mode are always shorter than the maximum communicable distances of the LS mode. This is because there are differences in the minimum values of the receiver sensitivity in the HS mode and the LS mode.

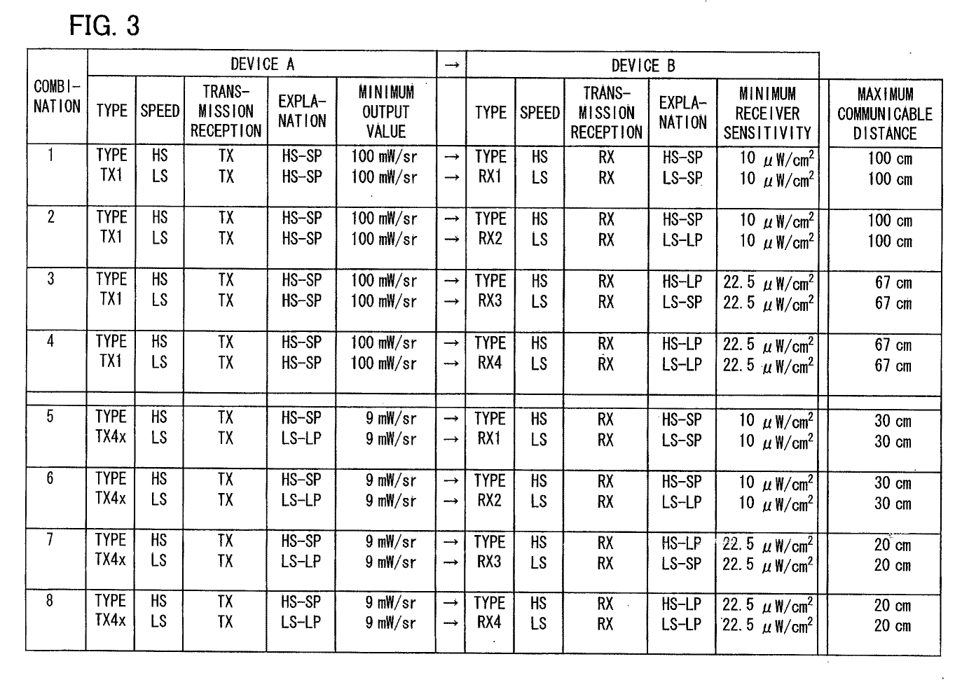

On the other hand, FIG. 3 shows a case where the minimum values of the receiver sensitivity of the HS mode and the LS mode are set equal with each other for the receiver sensitivity of the Device B shown in FIG. 20. HS, LS, SP, LP, TX, and RX respectively stand for: a high speed; a low speed; a standard power; a low power; a transmission side; and a reception side.

In the Combination 1 of FIG. 3 for example, the minimum value (4 μW/cm²) of the receiver sensitivity in the LS mode is set equal to the minimum value (10 μW/cm²) of the receiver sensitivity in the HS mode. By this, the maximum communicable distance in the LS mode becomes 100 cm, which is equal to the maximum communicable distance in the HS mode. Similarly in other exemplary combinations, the maximum communicable distances in the LS mode become equal to the maximum communicable distances in the HS mode once the minimum values of the receiver sensitivities in the LS mode are set equal to the minimum values of the receiver sensitivities in the HS mode.

That is to say, when the plurality of communication modes are provided, maximum communicable distances between the Device A and the Device B are limited by minimum values (in the case of exemplary combinations shown in FIG. 3, the maximum communicable distances in the HS mode) of maximum communicable distances in the respective communication modes. Therefore, the receiver sensitivities are set lower in the LS modes having the maximum communicable distances longer than the receiver sensitivities in the HS modes such that the maximum communicable distances in the HS modes and the LS modes are substantially equal in the plurality of the communication speed modes.

By this, while unwanted noise is easier to be received since conventional LS modes have the unnecessarily high receiver sensitivities, the optical space communication reception circuit 100 of the present embodiment is improved such that the LS modes are set up so as not to have any of unnecessary high receiver sensitivities; therefore, noise is less likely to be received. Thus, without shortening maximum communicable distances between the Device A and the Device B, it is possible to enhance the false operation prevention characteristics by reducing the influence of unwanted noise such as disturbance noise and the like.

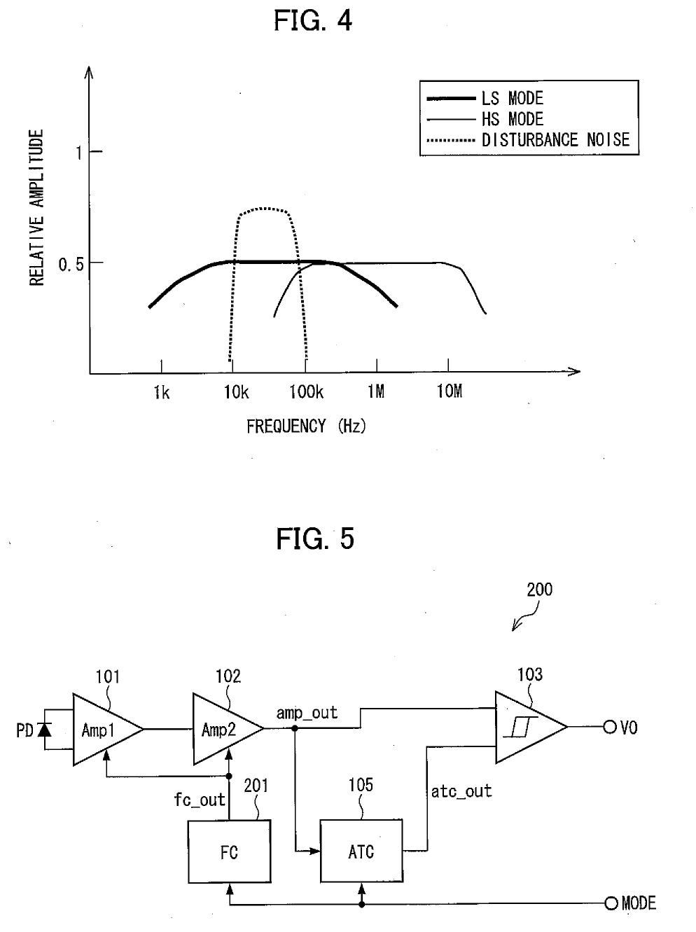

For example, FIG. 4 shows gain frequency characteristics in a case where a peak gain value in the LS mode and a peak gain value in the HS mode are set substantially equal. The vertical axis shows relative amplitude and the horizontal axis shows a frequency (Hz). In addition, a bold line shows the LS mode, a continuous line shows the HS mode, and a dashed line shows the disturbance noise.

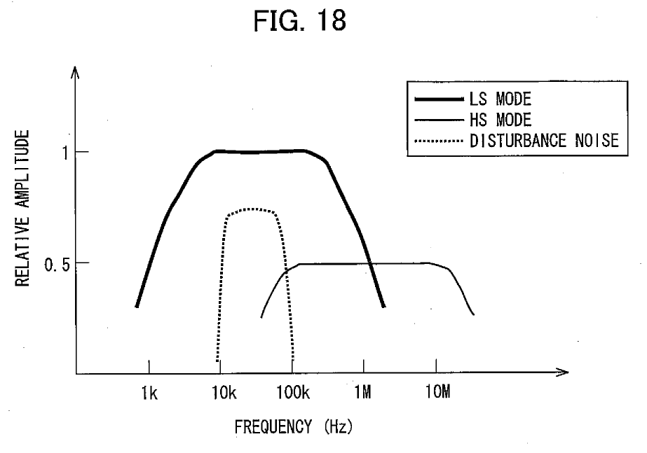

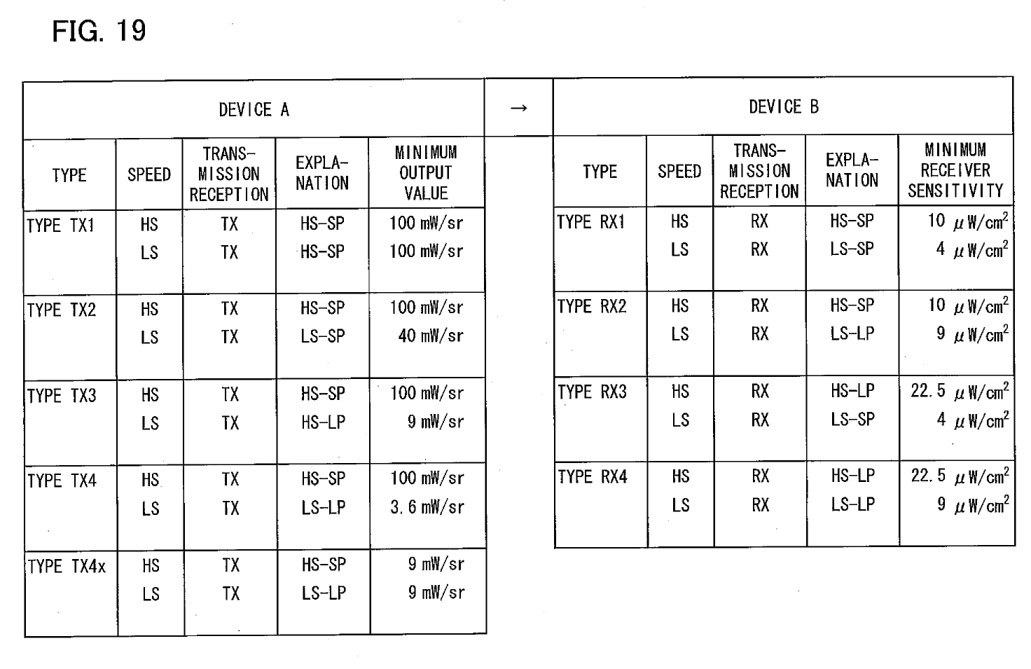

As shown in FIG. 18, conventional frequency characteristics are set up at a higher gain in the LS mode. On the other hand, in the case shown in FIG. 4, the peak gain in the LS mode is set, under control of the gain control circuit 104 and the threshold control circuit 105, to be substantially equal to the peak gain in the HS mode. That is to say, the peak gain in the LS mode is set lower than the peak gain in the LS mode shown in FIG. 18. It can be readily understood that the influence of the disturbance noise during the LS mode can be reduced in electrical spectrums of the disturbance noise by this.

The optical space communication reception circuit 100 of the present embodiment is configured to have the gain control circuit 104 and the threshold control circuit 105; however, the optical space communication reception circuit is not limited to this configuration. The threshold value of the hysteresis comparator 103, which is to be provided from the threshold control circuit 105, may be set in advance without any signals from external sources, so that the receiver sensitivity will be set solely by the gain controlling by the gain control circuit 104. In addition, it may be conversely arranged such that without any signals from outer sources, gains of the first amplifier 101 and the second amplifier 102, which gains are controlled by the gain control circuit 104 are set in advance, so that the receiver sensitivity will be set solely by the threshold control by the threshold control circuit 105.

Besides, the present invention is not limited to the optical space communication reception circuit 100 of the present embodiment, where the two communication speeds, the HS mode and the LS mode, are provided. The concepts of the present invention can be commonly applicable in cases where communication is made among three or more communication speeds.

Furthermore, since the infrared communication transmission reception devices 501A and 501B shown in FIG. 13 enhance the false operation prevention characteristics against noise by having the optical space communication reception circuit 100 of the present embodiment, it is possible to realize high reliability. Besides, since the infrared communication transmission reception devices 501A and 501B are configured so as not to have unnecessarily high receiver sensitivities, it is possible to reduce electricity consumption.

In addition, construction of the infrared communication system is not limited between two devices of the infrared communication transmission reception devices 501A and 501B. The infrared communication system is preferably constructed among a plurality of the infrared communication transmission reception devices having the optical space communication reception circuits 100 of the present embodiment. By this, it is possible to realize infrared communication systems in which the false operation prevention characteristics against the influence of disturbance noise are enhanced such that the generation of the communication disruption by the false operation is reduced.

Moreover, the infrared communicating devices 500A and 500B provided with the infrared communication transmission reception devices 501A and 501B can realize electronic devices having an infrared communication function, which is provided with the false operation prevention function while reduces the influence of the disturbance noise generated in the devices.

Presupposing the infrared communication, the description above discusses the IrDA, which is a general infrared communication code and standard. However, the present invention is neither limited to the IrDA nor to the infrared communication. The present invention is also applicable to communication where optical transmission is performed with light signals.

### Second Embodiment

With reference to the drawings, the following description deals with another embodiment of the present invention. Configurations other than those described in the present embodiment are identical with the embodiment 1. For easy explanation, members having the same functions as those described in Embodiment 1 are given the same reference numerals in the present embodiment, and explanation thereof is omitted.

FIG. 5 is a block diagram of an equivalent circuit, showing an exemplary configuration of an optical space communication reception circuit 200 of the present embodiment.

As shown in FIG. 5, the optical space communication reception circuit 200 of the present embodiment is similar to a configuration of the optical space communication reception circuit 100 of the embodiment 1 except that a gain control circuit 104 is eliminated therefrom. In addition, the optical space communication reception circuit 200 of the present embodiment further includes a frequency control circuit (FC) 201 for controlling frequency characteristics of a first amplifier 101 and a second amplifier 102 based on a control signal inputted from a mode switch terminal MODE.

Furthermore, as in the case of the optical space communication reception circuit 100, the optical space communication reception circuit 200 of the present embodiment includes an HS mode and an LS mode which support different communication speeds. As shown in FIG. 2, in the optical space communication reception circuit 200, the HS mode and the LS mode are alternately switched over by a control signal outputted from a control signal output terminal MODE of a communication controller 502A.

In detail, the frequency control circuit 201 switches between frequency controlling for the high speed communication and frequency controlling for low speed communication, in accordance with the control signal inputted from the mode switch terminal (MODE). (The frequency controlling for the high speed communication and frequency controlling for the low speed communication are set in advance.) Meanwhile, the threshold control circuit 105 switches between threshold controlling for the high speed communication and threshold controlling for the low communication speed according to the control signal. (The threshold controlling for the high speed communication and the threshold controlling for the low speed communication are set in advance.)

By this, the frequency controlling and the threshold controlling are performed, and thereby the receiver sensitivity of the optical space communication reception circuit 200 is controlled. That is to say, when the frequency controlling and the threshold controlling corresponding to the high speed communication are performed, the receiver sensitivity corresponding to the high speed communication is set up while the receiver sensitivity corresponding to the low speed communication is set up when the gain controlling and the threshold controlling corresponding to the low speed communication are performed.

Thus, a condition, where the receiver sensitivity for the high speed communication is set up, becomes the HS mode and a condition, where the receiver sensitivity for the low speed communication is set up, becomes the LS mode. Therefore, the HS mode and the LS mode can be switched between by the control signal.

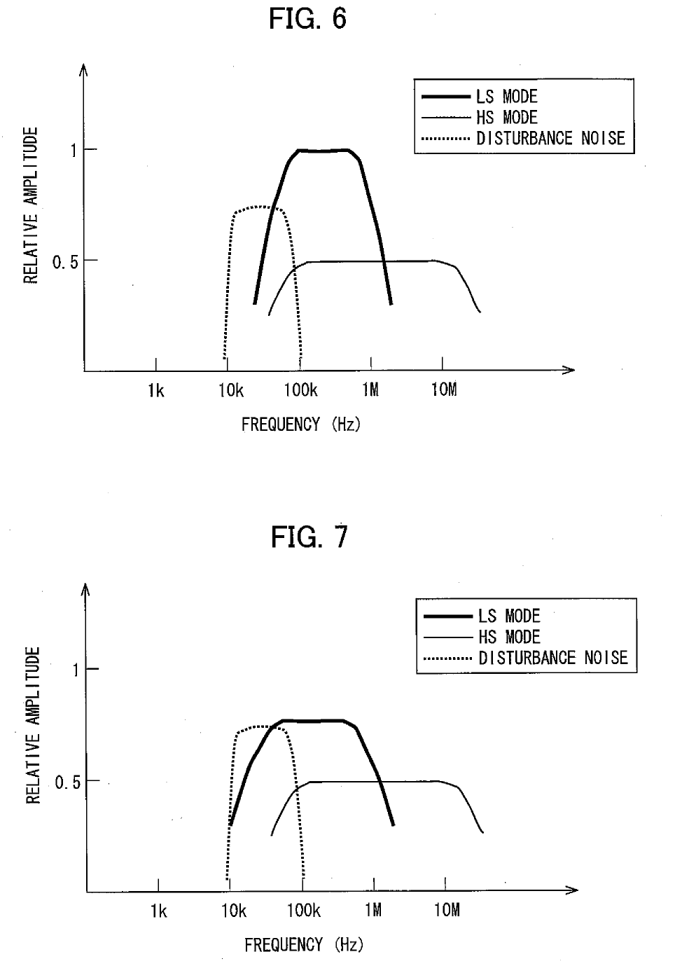

For example, FIG. 6 shows gain frequency characteristics of a case where while the peak gain value of the LS mode is maintained, the frequency characteristics of the first amplifier 101 and the second amplifier 102 are shifted to the high frequency side, as compared to normal frequency ranges of signals, such that actual receiver sensitivity of the LS mode is lowered. The vertical axis shows relative amplitude and the horizontal axis shows a frequency (Hz). In addition, the bold line indicates the LS mode, the continuous line indicates the HS mode, and the dashed line indicates the disturbance noise.

As FIG. 18 shows, in conventional gain frequency characteristic, the disturbance noise is generated in a frequency range overlapping with a frequency range of the LS mode. On the other hand, in the case shown in FIG. 6, while the peak gain value is maintained, the frequency characteristic of the LS mode is shifted to the higher frequency side, as compared to the electrical spectrum of the frequency characteristic of the disturbance noise. By this, it can be readily understood that the influence of the disturbance noise during the LS mode can be reduced in electrical spectrums of the disturbance noise by this.

Besides, it is possible to further reduce the influence of the disturbance noise than does the lowering the receiver sensitivity of the LS mode, by suitably setting a relation between the frequency range of the disturbance noise and the frequency characteristics of the first amplifier 101 and the second amplifier 102 as described above. In addition, by suitably setting this relation, it is possible to enhance an S/N ratio, where S is the original signal and N is unwanted noise.

The optical space communication reception circuit 200 of the present embodiment is configured to have the frequency control circuit 201 and the threshold control circuit 105; however, the present invention is not limited to this configuration. The threshold value of the hysteresis comparator 103, which is to be provided from the threshold control circuit 105, may be set in advance without any signals from external sources, so that the receiver sensitivity will be set solely by the frequency controlling by the frequency control circuit 201. In addition, it may be conversely arranged such that without any signals from outer sources, frequency characteristics of the first amplifier 101 and the second amplifier 102, which frequency characteristics are controlled by the frequency control circuit 201 are set in advance, so that the receiver sensitivity will be set solely by the threshold controlling by the threshold control circuit 105.

Besides, adjustment of the receiver sensitivity can be performed by both adjusting the setting of the peak gain value, as shown in FIG. 4 and by adjusting the shifting of the frequency characteristic to the high frequency side, as shown in FIG. 6.

FIG. 7 shows gain frequency characteristics of the case where both of the adjustments described above are performed in the LS mode. The vertical axis shows relative amplitude and the horizontal axis shows a frequency (Hz). In addition, the bold line shows the LS mode, the continuous line shows the HS mode, and the dashed line shows the disturbance noise.

In the case shown in FIG. 7, the peak gain value of the LS mode is set (i) lower than the peak gain value of the LS mode shown in FIG. 18 and (ii) higher than the peak gain value of the LS mode shown in FIG. 4. Furthermore, the frequency characteristic of the LS mode is shifted (i) to the higher frequency side, as compared to the frequency characteristic of the LS mode shown in FIG. 18 and (ii) to the lower frequency side, as compared to the frequency characteristic of the LS mode shown in FIG. 6.

By this, it is possible to optimize the setting of the receiver sensitivity under the influence of the disturbance noise, by adjusting relations between the frequency characteristics and the gains. In addition, this adjustment can be applied for a case, which is described later, where the gains and the frequency characteristic are adjusted by noise detection.

### Third Embodiment

The following describes another embodiment of the present invention, with reference to the drawings. Note that configurations other than those described in the present embodiment are identical with the configurations of the Embodiments 1 and 2. Besides, for easy explanation, members having the same functions as those described in the drawings of the Embodiments 1 and 2 are given the same reference numerals in the present embodiment, and explanation thereof is omitted.

The Embodiments 1 and 2 describe the setting and the controlling for reducing noise influence without carrying out noise detection, presupposing that the devices are subject to the noise influence. However, the present embodiment describes an arrangement in which the noise is detected and then the noise influence is reduced according to the detected noise.

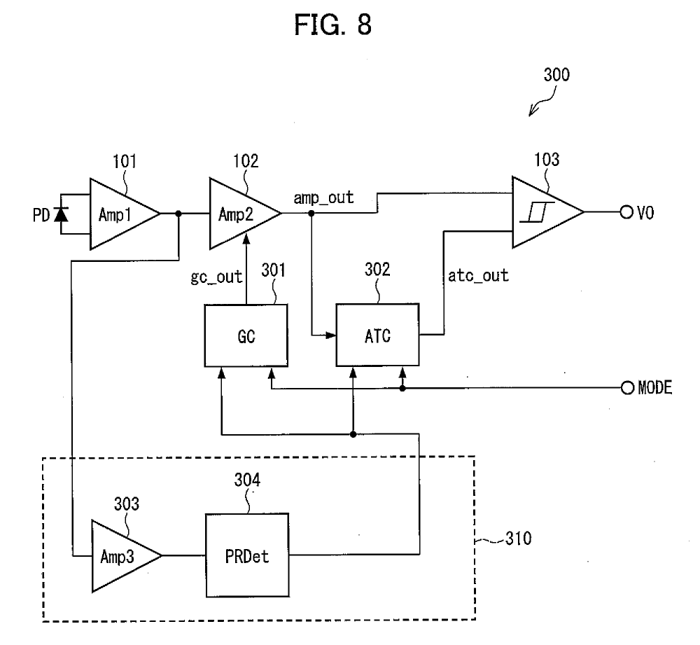

FIG. 8 shows a block diagram of an equivalent circuit, illustrating an exemplary configuration of an optical space communication reception circuit 300 of the present embodiment.

As shown in FIG. 8, the optical space communication reception circuit 300 of the present embodiment includes a photo diode (PD); a first amplifier 101; a second amplifier 102; a hysteresis comparator circuit 103; a voltage output terminal; a mode switch terminal (MODE); a noise detection circuit 310 for detecting unwanted noise from a voltage signal outputted from the first amplifier 101; a gain control circuit (GC) 301 for controlling gain of the second amplifier 102 based on a control signal inputted from the mode switch terminal (MODE) and a detection signal outputted from the noise detection circuit 310; and a threshold control circuit (ATC) 302 for providing a threshold value_{atc out} of the hysteresis comparator circuit 103 while controlling it based on a voltage signal_{amp out} outputted from the second amplifier 102, a control signal inputted from the mode switch terminal (MODE), and a detection signal outputted from the noise detection circuit 310.

The noise detection circuit 310 includes an amplifier for noise detection (Amp 3) 303 which amplifies, independently from the second amplifier 102, a voltage signal outputted from the first amplifier 101; and a pulse cycle detection circuit (PRDet) 304 which detects a pulse cycle of a received signal by using a voltage signal outputted from the amplifier for noise detection 303. Besides, a detection signal is outputted from the pulse cycle detection circuit 304 to the gain control circuit 301 and the threshold control circuit 302, based on the result of detecting the pulse cycle of the received signal.

The optical space communication reception circuit 300 of the present embodiment has an HS mode and an LS mode which support different communication speeds. In the optical space communication reception circuit 300, the HS mode and the LS mode are alternately switched between by control signals outputted from the control signal output terminal (MODE) of a communication controller 502A.

Beside, in the optical space communication reception circuit 300, receiver sensitivity and a frequency characteristic in the LS mode are set according to intensity and an electrical spectrum of a signal in the LS mode. In addition, receiver sensitivity and a frequency characteristic in the HS mode are set according to intensity and an electrical spectrum of a signal in the HS mode.

Then, the gain control circuit 301 receives control signals inputted from the mode switch terminal (MODE) and then performs gain controlling, according to the settings of the receiver sensitivity and the frequency characteristic in the LS mode as well as the receiver sensitivity and the frequency characteristic in the HS mode. Besides, simultaneously, the threshold control circuit 302 receives control signals inputted from the mode switch terminal (MODE) and then performs the threshold controlling. Thus, in the HS mode, communication is performed with the maximum communicable distance of the HS mode, whereas communication is performed with the maximum communicable distance of the LS mode in the LS mode.

Each mode described above is arranged such that if it is judged that the noise is inputted, the noise detection circuit 310 outputs the detection signal to the gain control circuit 301 and the threshold control circuit 302 such that the gain control circuit 301 and the threshold control circuit 302 perform control so as to lower the receiver sensitivity.

Suppose, for example, that (i) the maximum communicable distance is set at 100 cm for the receiver sensitivity in the LS mode and the maximum communicable distance is set at 70 cm for the receiver sensitivity in the HS mode; and (ii) communication cannot be performed in the case above since unwanted noise is received in the LS mode. In this case, the noise detection circuit 310 determines that the noise is received, and outputs the detection signal to the gain control circuit 301 and the threshold control circuit 302. In other words, the noise detection circuit 310 sends, to the gain control circuit 301 and the threshold control circuit 302, the result of detecting the noise input. By this, the gain control circuit 301 and the threshold control circuit 302 lower receiver sensitivities in the LS mode such that the maximum communicable distance in the LS mode is 70 cm, which is substantially equal to the maximum communicable distance in the HS mode (70 cm).

By this, it is possible in the optical space communication reception circuit 300 that the false operation is made less likely to occur by lowering the receiver sensitivity, if noise is detected. On the other hand, it is also possible in the optical space communication reception circuit 300 that a longer maximum communicable distance is maintained by maintaining the receiver sensitivity set in the respective communication speed modes, when noise is not detected as well as when the noise is detected little, that is, a condition where the noise exists little.

In the arrangement described above, the receiver sensitivity in the LS mode is lowered such that the maximum communicable distance in the LS mode becomes substantially equal to the maximum communicable distance set in the HS mode; however, the lowering of the receiver sensitivity is not limited to this. The lowering of the receiver sensitivity can be performed as suitable with relations between presupposed noise conditions (e.g., noise volume, waveform of noise, frequency of noise, and the like) and signal ranges in the respective communication speeds. That is to say, the settings of the gain control circuit 301 and the threshold control circuit 302 should be switched over to circuit conditions corresponding to the communication speeds.

Furthermore, the following describes a case where communication is performed first in the LS mode, and then performed in the HS mode. In this case, after the communication in the LS mode ends, the circuit condition is switched over to, by a control signal inputted from the mode switch terminal MODE, the receiver sensitivity in the HS mode, and the communication speed mode is switched over to the HS mode.

However, there is a case that unwanted noise is received at the time of communication in the LS mode, thus the communication in the LS mode does not end properly. In this case, communication is disrupted arbitrarily in conventional reception circuits.

In this case, it is possible that the noise detection circuit 310 outputs the detection signal to the gain control circuit 301 and the threshold control circuit 302 such that the conditions of the receiver sensitivity are switched over, and communication in the HS mode becomes available. On the other hand, it is also possible to switch the setting to the circuit condition corresponding to the communication speed for the HS mode. By this, even when the communication in the LS mode does not end properly and there are no control signal inputted from the mode switch terminal (MODE), it is still possible to cancel the LS mode and then to switch over to the HS mode by switching over the conditions of the receiver sensitivities, that is, by switching over the communication speed modes. Therefore, it is possible to prevent the communication disruption.

The following describes in detail with how the noise detection circuit 310 detects noise.

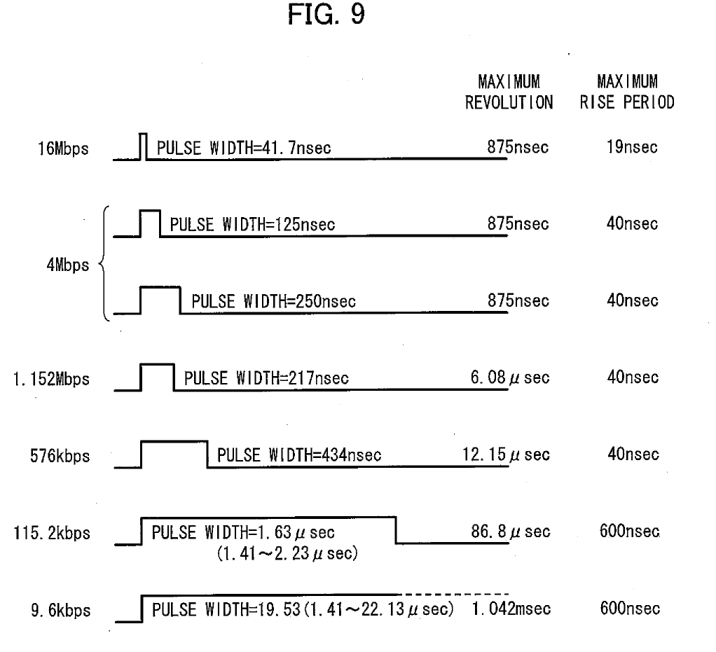

FIG. 9 shows pulse width, maximum pulse cycle, and a maximum rise period of a communication signal, which are stipulated by the IrDA. That is to say, the IrDA supports communication speeds of 16 Mbps, 4 Mbps, 1.152 Mbps, 576 kbps, 115.2 kbps, and 9.6 kbps.

In the noise detection circuit 310, a pulse cycle detection circuit 304 detects a maximum interval period between pulses in a received signal, and judges whether or not the detected maximum interval period is within the ranges of the maximum revolutions shown in FIG. 9.

That is to say, if the interval period between pulses falls between 875 nsec to 1.042 msec, it is more likely a case that a normal signal is received. In contrast, if the interval period is below 875 nsec or over 1.042 msec, it is more likely a case that unwanted noise is received. By this, it is possible that the noise detection circuit 310 detects the noise both precisely and easily.

In the IrDA code and standard, there is the lowest communication speed of 2.4 kbps below the communication speed of 9.6 kbps. By protocol, however, the first communication speed is set at 9.6 kbps and the communication speed of 2.4 kbps is practically not used. By this, it is preferred to judge a signal received at a communication speed below 9.6 kbps as noise.

Besides, the optical space communication reception circuit 300 of the present embodiment includes the HS mode that is the communication speed mode above communication speed of 115 kbps and the LS mode that is the communication speed mode below or equal to the communication speed of 115 kbps.

Conventionally, as FIG. 18 shows, it has been problematic that communication is subject to the noise influence since the receiver sensitivity is too high in the communication speed range of the LS mode. The LS mode corresponds to the communication speeds of 115.kbps and 9.6 kbps shown in FIG. 9. Maximum revolution of the communication speed of 115.2 kbps is 86.8 μsec and maximum revolution of the communication speed of 9.6 kbps is 1.042 msec

Therefore, it is possible to detect noise effectively by judging whether the interval period between pulses detected by the noise detection circuit 310 is below or equal to 10 μsec or whether the interval period is above or equal to 1.1 msec.

Besides, the noise detection circuit 310 can detect noise effectively by adjusting, to an electrical spectrum of the unwanted noise expected to be received, a frequency characteristic of the amplifier for noise detection 303 which constitutes the noise detection circuit 310.

In the optical space communication reception circuit 300 of the present embodiment, it is preferable that gain of the second amplifier 102, the gain controlled by the gain control circuit 301, is set in advance without any signals from outer sources and that a threshold value of the hysteresis comparator circuit 103, which threshold value controlled by the threshold control circuit 302, is set in advance without any signals from outer sources.

By including the pulse cycle detection circuit 304, the noise detection circuit 310 detects the maximum interval period between pulses in the received signal so as to judge whether the signal is noise or not; however, the configuration is not limited to this. The pulse cycle detection circuit 304 is preferably configured to detect pulse width so as to judge whether the received signal is noise or not.

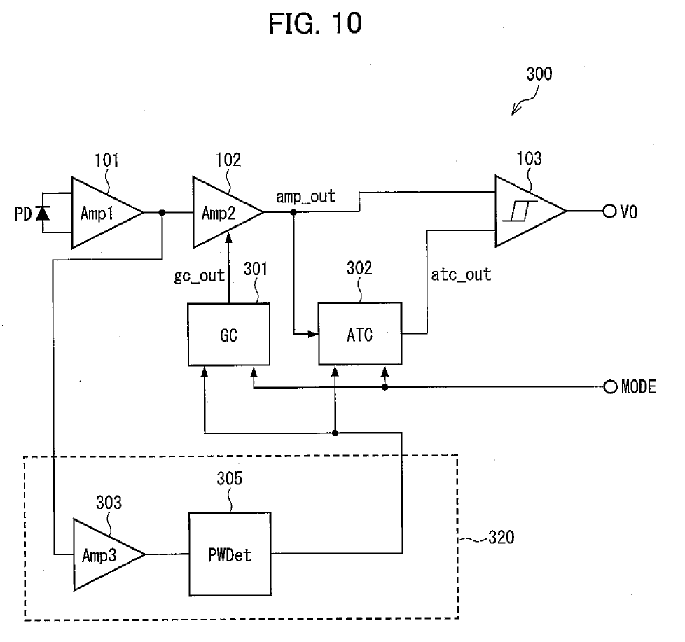

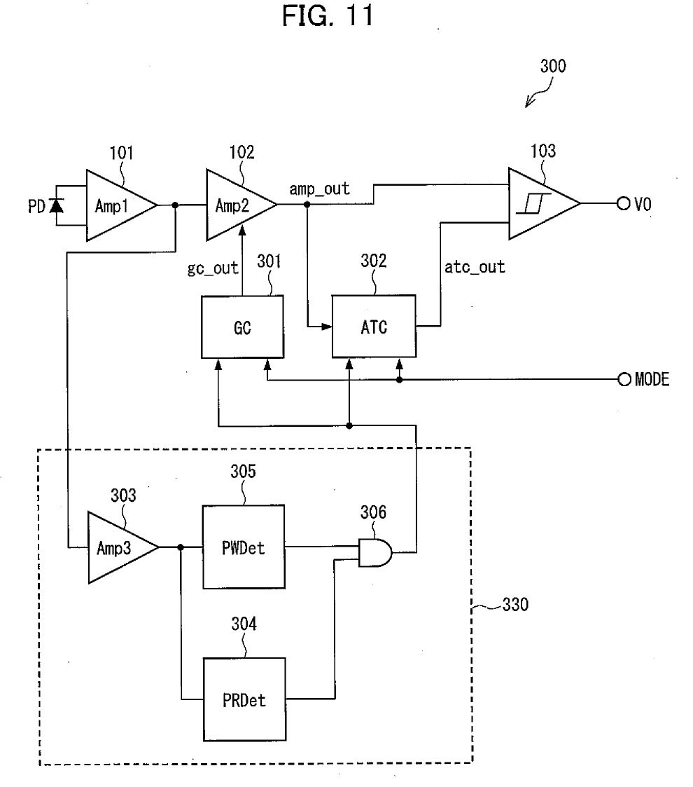

FIG. 10 is a block diagram of an equivalent circuit, showing an exemplary configuration of an optical space communication reception circuit 300 which includes a noise detection circuit 320, instead of a noise detection circuit 310.

As shown in FIG. 10, the noise detection circuit 320 includes an amplifier for noise detection 303 and a pulse width detection circuit (PWDet) 305 for detecting pulse width of a received signal by using a voltage signal outputted from the amplifier for noise detection 303. In addition, the pulse width detection circuit 305 outputs a detection signal to a gain control circuit 301 and a threshold control circuit 302, in accordance with a result of detecting the pulse width of the received signal.

In the noise detection circuit 320, the pulse width detection circuit 305 detects the pulse width of the received signal, and judges whether the detected pulse width falls within the ranges of the pulse width of the communication speeds shown in FIG. 9.

That is to say, if the pulse width falls within the range from 41.7 nsec to 19.53 μsec, it is most likely a case that a normal signal is being received. In contrast, if the pulse width is below 41.7 nsec or above 19.53 μsec, it is most likely a case that unwanted noise is being received. By this, the noise detection circuit 310 can detect the noise both precisely and easily.

Besides, the noise detection circuit 320 can detect the noise effectively by judging the detected pulse width, based on the detection criterion of the range from the pulse width of 9.6 kbps to that of 115 kbps.

In addition, it is preferable to detect both the maximum interval period between pulses and the pulse width from the received signal so as to judge whether the received signal is noise or not.

FIG. 11 is a block diagram of an equivalent circuit, showing an exemplary configuration of an optical space communication reception circuit 300 which includes a noise detection circuit 330, instead of a noise detection circuit 310.

As shown in FIG. 11, the noise detection circuit 330 includes an amplifier for noise detection 303, a pulse cycle detection circuit 304, a pulse width detection circuit 305, and a logic gate 306 for receiving signals outputted from the pulse cycle detection circuit 304 and the pulse width detection circuit 305. In addition, the logic gate 306 outputs a detection signal to a gain control circuit 301 and a threshold control circuit 302, based on a result of detecting the pulse cycle and the pulse width of the received signals.

The noise detection circuit 330 performs the logic operation AND on the result of noise detection based on the pulse cycle and on the result of noise detection based on pulse width, and determines that unwanted noise is received, if both of the results of noise detection show that a received signal is noise. By this, accuracy of the noise detection can be further improved.

The optical space communication reception circuit 300 above switches over the conditions of receiver sensitivity so as to respond to the noise influence, when the unwanted noise is detected. Besides, it is also possible to optimize receiver sensitivities for communication speeds, by detecting the communication speeds in addition to detecting the unwanted noise.

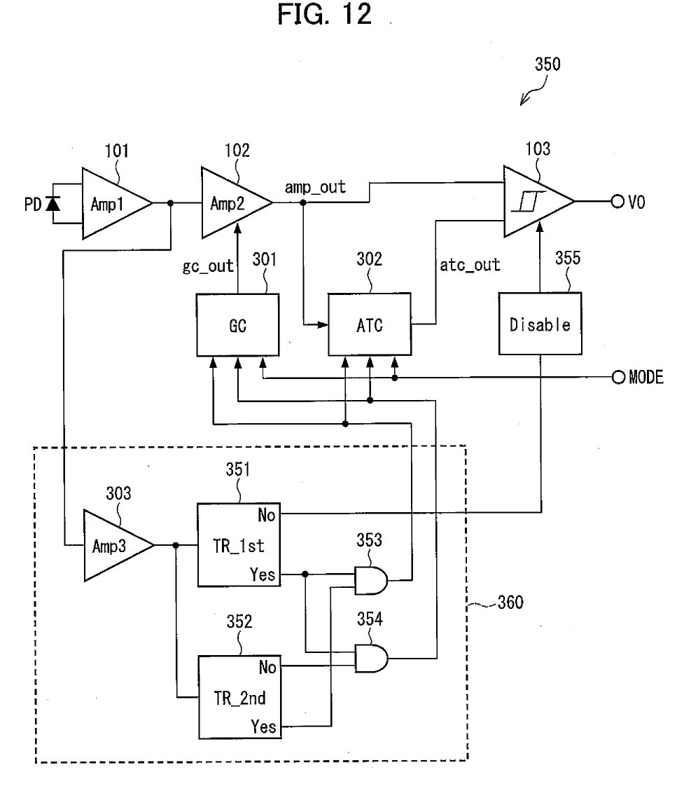

FIG. 12 is a block diagram of an equivalent circuit, showing an exemplary configuration of an optical space communication reception circuit 350 of the present embodiment.

As shown in FIG. 12, the optical space communication reception circuit 350 of the present embodiment includes, in addition to a configuration of an optical space communication reception circuit 300 from which a noise detection circuit 310 is omitted, (i) a communication state detection circuit 360 for detecting unwanted noise and communication speed from a voltage signal outputted from a first amplifier 101 and (ii) a disable circuit 355 for instructing a voltage output terminal (VO) to stop outputting a signal, based on the detection signal outputted from the communication state detection circuit 360.

The communication state detection circuit 360 includes an amplifier 303 for noise detection (noise detection amplifier 303), a first pulse rise period detection circuit (TR_{—}1st) 351, a second pulse rise detection circuit (TR_{—}2nd) 352, and logic gates 353 and 354. The communication state detection circuit 360 uses the maximum rise periods of the communication speeds, which are shown in FIG. 9, as criteria for judging noise and communication speeds.

A first judgment-criterion-period is set in the first pulse rise period detection circuit 351. The first pulse rise period detection circuit 351 compares, with the first judgment-criterion-period, a rise period of a received pulse outputted from the amplifier for noise detecting 303. If the rise period of the received pulse is shorter than the first judgment-criterion-period, the first pulse rise period detection circuit 351 determines that the received signal is a normal signal, and then outputs a signal from an output terminal (Yes) to the logic gates 353 and 354. In contrast, if the rise period of the received pulse is longer than the first judgment-criterion-period, the first pulse rise period detection circuit 351 determines that the received signal is not a normal signal. That is to say, the first pulse rise period detection circuit 351 determines that the received signal is the unwanted noise, and outputs a signal from an output terminal (No) to the disable circuit 355. The disable circuit 355 stops signal output from a voltage output terminal (VO), upon receiving the signal outputted from the first pulse rise period detection circuit 351.

A second judgment-criterion-period, which is shorter than the first judgment-criterion-period, is set in the second pulse-rise-period detection circuit 352. The second pulse-rise-period detection circuit 352 compares, with the second judgment-criterion-period, the rise period of the received pulse outputted from the amplifier for noise detecting 303. If the rise period of the received pulse is shorter than the second judgment-criterion-period, the second pulse-rise-period detection circuit 352 outputs a signal from an output terminal (Yes) to the logic gate 353. In contrast, if the rise period of the received pulse is longer than the second-judgment-criterion period, the second pulse-rise-period detection circuit 352 outputs a signal from an output terminal (No) to the logic gate 354.

The logic gate 353 inputs the output signal from the output terminal (Yes) of the first pulse rise period detection circuit 351 and the output signal form the output terminal (Yes) of the second pulse-rise-period detection circuit 352, and outputs a signal to a gain control circuit 301 and a threshold control circuit 302 when both of the output signals are inputted. Both of the outputted signals are inputted in a case that the rise period of the received pulse is shorter than the first judgment-criterion-period and the second judgment-criterion-period. In accordance with a communication speed in this case, the gain control circuit 301 and the threshold control circuit 302 optimize the receiver sensitivity.

The logic gate 354 inputs the output signal from the output terminal (Yes) of the first pulse rise period detection circuit 351 and the output signal from the output terminal (No) of the second pulse-rise-period detection circuit 352, and outputs a signal to the gain control circuit 301 and the threshold control circuit 302 when both signals are inputted. Both of the output signals are inputted in a case that the rise period of the received pulse is shorter than the first judgment-criterion-period and longer than the second judgment-criterion-period. In accordance with a communication speed in the case, the gain control circuit 301 and the threshold control circuit 302 optimize the receiver sensitivity.

That is to say, the communication state detection circuit 360 categorizes the rise periods of the received pulses into any one of (i) longer than the first judgment-criterion-period, (ii) shorter than the first judgment-criterion-period and longer than the second judgment-criterion-period, and (iii) shorter than the second judgment-criterion-period.

By this, since the rise period of the pulse is shorter as the communication speed is faster, it is possible to judge, for example, that (i) a received signal is the unwanted noise if the rise period of the received pulse is longer than the first judgment-criterion-period, (ii) the received signal is a signal of the first communication speed if the rise period of the received pulse is shorter than the first judgment-criterion-period and longer than the second judgment-criterion-period, and (iii) the received signal is a signal of the second communication speed, which is faster than the first communication speed, if the rise period of the received pulse is shorter than the second judgment-criterion-period.

Thus, it is possible in the optical space communication reception circuit 350 that, if the received signals are judged to be the unwanted noise, the disable circuit 355 stops signal output and that, if the received signal is judged to be either the signal of the first communication speed or of the second communication speed, the gain control circuit 301 and the threshold control circuit 302 optimize the receiver sensitivity for the respective communication speeds.

Besides, as shown in FIG. 9, the maximum value of the rise period in the communication speed below 115 kbps is set at 600 nsec by the IrDA code and standard. In addition, the maximum vale of the rise period in the communication speed over 115 kbps is set at 40 nsec.

By this, the communication state detection circuit 360 sets the first judgment-criterion-period between 600 to 700 nsec and the second judgment-criterion-period between 40 to 50 nsec, and performs noise detecting effectively and optimally. Thus, the communication state detection circuit 360 can set the state of the first communication speed as the HS mode and the state of the second communication speed as the LS mode.

Though the optical space communication reception circuits 300 and 350 of the present embodiment include the gain control circuit 301, yet they preferably include a frequency control circuit having identical functions as the frequency control circuit 201, instead of the gain control circuit 301.

Besides, in the optical space communication reception circuit s 300 and 350 of the present embodiment, the noise detection circuits 310, 320, 330, and the communication state detection circuit 360 output the output signals to the gain control circuit 301 and the threshold control circuit 302, on judging that the noise is received, and then control receiver sensitivities respectively by the gain control circuit 301 and by the threshold control circuit 302.

However, the noise detection circuits 310, 320, 330 and the communication state detection circuit 360 do not necessarily adjust the receiver sensitivity only. Those circuits can also perform transmission of signals to other configurations and the like, and then optimize the conditions of the optical space communication reception circuits 300 and 350, based on the results of noise detecting.

The present invention is not limited to the description of the embodiments above, but may be altered by a skilled person within the scope of the claims. An embodiment based on a proper combination of technical means disclosed in different embodiments is encompassed in the technical scope of the present invention.

The present invention can be used for an optical space communication reception circuit which transmits, by optical space such as infrared communication for example, a light signal under settings respectively corresponding to the plurality of communication speed modes to be switched over.

As described above, an optical space communication reception circuit according to the present invention for receiving a signal in switched-over communication speed modes and under settings respectively corresponding to the communication speed modes is arranged such that receiver sensitivity in the respective communication speed modes is set in advance such that maximum communicable distances in the communication speed modes are substantially equal.

Besides, the optical space communication reception circuit according to the present invention for receiving a signal in switched-over communication speed modes and under settings respectively corresponding to the communication speed modes includes a receiver sensitivity adjustment circuit for adjusting receiver sensitivity in the respective communication speed modes such that maximum communicable distances in the communication speed modes are substantially equal.

Therefore, since it is avoided that communication speed modes have unnecessarily high receiver sensitivity, it is possible to reduce the influence of unwanted noise such as disturbance noise, power supply noise, and the like, and to make unwanted false operation less likely to occur. Thus, the effect can be attained, the effect that optical space communication reception circuit capable of enhancing the false operation prevention characteristics, without shortening the maximum communicable distance between the communicating devices is provided.

Furthermore, according to the configurations of the optical space communication reception circuit described above, the effect can be attained, the effect that a large amount of cost compensation is cut, as compared to a response to the disturbance noise using the optical filter. Besides, it is possible to attain the effect of optimizing the optical space communication reception circuit only, without necessity of installing complex systems as conventionally proposed, the system performing detection of communication quality.

Besides, the optical space communication reception circuit according to the present invention for receiving a signal in switched-over communication speed modes and under settings respectively corresponding to the communication speed modes includes the receiver sensitivity adjustment circuit which, if the signal cannot be received due to noise input, switches over to receiver sensitivity for a communication speed mode selected subsequently to a communication speed mode used when noise is inputted or switches a setting of the optical space communication reception circuit to a circuit condition corresponding to a communication speed for the communication speed mode selected subsequently.

Therefore, it is possible to cancel the communication speed mode used when the noise is inputted and then to switch over to the communication speed mode selected subsequently. Thus, communication disruption can be prevented so as to make unwanted false operation less likely to occur. Consequently, the effect of providing the optical space communication reception circuit can be attained, the optical space communication reception circuit capable of enhancing the false prevention characteristic against noise, without shortening the maximum communicable distance.

Besides, the optical space communication device according to the present invention includes the optical space communication reception circuit which includes the light receiving element for receiving a sent light and the optical space communication transmission circuit which includes the light emitting element for outputting a light signal.

Therefore, the effect of providing the optical space communication device can be gained, the optical space communication device having the high false operation prevention characteristic against noise and the transmission reception function, provided with the optical space communication reception circuit capable of enhancing the false operation prevention characteristic against noise.

Besides, the optical space communication system according to the present invention includes the optical space communication device. For that, the effect of providing the optical space communication system can be attained, the optical space communication system excelling in false prevention capability against noise and reducing the generation of communication disruption caused by the false operation.

In additions the optical space communication system according to the present invention for including the optical space communication reception circuit for receiving a signal in switched-over communication speed modes and under settings respectively corresponding to the communication speed modes is arranged such that the optical space communication reception circuit includes the receiver sensitivity adjustment circuit which, if the signal cannot be received due to noise input, switches over to receiver sensitivity for a communication speed mode selected subsequently to a communication speed mode used when noise is inputted or switches a setting of the optical space communication reception circuit to a circuit condition corresponding to a communication speed for the communication speed mode selected subsequently.

Therefore, it is possible to cancel the communication speed mode used when the noise is inputted, and then to switch over to the communication speed mode picked subsequently. Consequently, it is possible to make the unwanted false operation less likely to occur by preventing the communication disruption. Thus, the effect of providing the optical space communication system can be attained, the optical space communication system reducing the generation of the communication disruption.

Besides, the electronic device according to the present invention includes the optical space communication device. Thus, the effect of providing the electronic device can be attained, the electronic device reducing the influence of the noise generated internally, and making the false operation less likely to occur.

In addition, the optical space communication reception circuit according to the present invention includes an amplifying stage for amplifying the received signal and a waveform shaping outputting stage for shaping a waveform of a signal outputted from the amplifying stage, based on a threshold value, and the setting of the receiver sensitivity is preferably carried out by at least one of (i) substantially equalizing maximum gains of the amplifying stage in the respective communication speed modes and (ii) adjusting the threshold value of the waveform shaping outputting stage in the respective communication speed modes.

According to the above configuration, it is possible to easily set the receiver sensitivity in the respective communication speed modes by setting any one of the maximum gain of the amplifying stages and the threshold value of the waveform shaping outputting stages.

Besides, the optical space communication reception circuit according to the present invention includes an amplifying stage for amplifying the received signal and a waveform shaping outputting stage for shaping a waveform of a signal outputted from the amplifying stage, based on a threshold value, and the setting of the receiver sensitivity is preferably carried out by at least one of (i) shifting a frequency range of the amplifying stage in the respective communication speed modes and (ii) adjusting the threshold value of the waveform shaping outputting stage in the respective communication speed modes.

According to the above configuration, it is possible to easily set the receiver sensitivity in the respective communication speed modes solely by setting any one of the frequency ranges of the amplifying stages and the threshold value of the waveform shaping outputting stage. In addition, in a case of setting the frequency ranges of the amplifying stages, it is possible to enhance the S/N ratio, where S is a normal signal and N is unwanted noise.

Furthermore, the optical space communication reception circuit according to the present invention includes an amplifying stage for amplifying the received signal and a waveform shaping outputting stage for shaping a waveform of a signal outputted from the amplifying stage, based on a threshold value, and the receiver sensitivity adjustment circuit preferably includes at least one of (i) a gain control circuit for controlling a maximum gain of the amplifying stage according to one of the communication speed modes in which the optical space communication reception circuit receives the signal, and (ii) a threshold control circuit for controlling a threshold value of the waveform shaping outputting stage according to one of the communication speed modes in which the optical space communication reception circuit receives the signal.

According to the above configuration, the receiver sensitivity adjustment circuit includes any one of the gain control circuit for controlling the maximum gain of the amplifying stage and the threshold control circuit for controlling the threshold value of the waveform shaping outputting stage for the plurality of the communication speed modes; therefore, it is possible to easily adjust the receiver sensitivity in the respective communication speed modes by controlling the maximum gain of the amplifying stage or the threshold value of the waveform shaping outputting stage.

Besides, the optical space communication reception circuit according to the present invention includes an amplifying stage for amplifying the received signal and a waveform shaping outputting stage for shaping a waveform of a signal outputted from the amplifying stage, based on a threshold value, and the receiver sensitivity adjustment circuit preferably includes at least one of (i) a frequency control circuit for controlling a frequency range of the amplifying stage according to one of the communication speed modes in which the optical space communication reception circuit receives the signal, and (ii) a threshold control circuit for controlling the threshold value of the waveform shaping outputting stage according to one of the communication speed modes in which the optical space communication reception circuit receives the signal.

According to the above configuration, the receiver sensitivity adjustment circuit includes any one of the frequency control circuit for controlling the frequency ranges of the amplifying stages and the threshold control circuit for controlling the threshold value of the waveform shaping outputting stages for the plurality of communication speed modes; therefore, it is possible to easily adjust the receiver sensitivity in the respective communication speed modes by controlling any one of the frequency ranges of the amplifying stages and the threshold value of the waveform shaping outputting stages. In addition, in a case of controlling the frequency ranges of the amplifying stages, it is possible to enhance the S/N ratio, where S is a normal signal and N is unwanted noise.

Moreover, the optical space communication reception circuit according to the present invention is preferably arranged such that the receiver sensitivity adjustment circuit adjusts the receiver sensitivity when noise is inputted.

According to the above configuration, it is possible to make the false operation less likely to occur since the receiver sensitivity in the communication speed mode used at the time of the noise input is lowered under a condition where noise is huge and communication is more likely to be influenced by the noise. Besides, it is also possible to maintain longer maximum communicable distances by maintaining the receiver sensitivity set in the respective communication speed modes under a condition where noise is not existent or is not so significant.

Besides, the optical space communication reception circuit according to the present invention is preferably configured such that the receiver sensitivity adjustment circuit, if it is impossible to receive the signal due to noise input, switches over to receiver sensitivity for a communication speed mode selected subsequently to a communication speed mode used when noise is inputted.

When the noise is inputted, there may be cases that signals cannot be properly received and the communication mode used at the time of the noise input cannot end properly. In this case, communication is disrupted arbitrarily.

On the other hand, according to the above configuration, when the signals cannot be received due to the noise input, the receiver sensitivity adjustment circuit switches the receiver sensitivity to the receiver sensitivity in the communication speed mode selected subsequently to the communication speed mode used at the time of the noise input such that it is possible to cancel the communication speed mode used when the noise is inputted, and then to switch over to the communication speed mode selected subsequently. Therefore, the communication disruption can be prevented.

Besides, the optical space communication reception circuit according to the present invention includes a pulse cycle detection circuit for measuring an interval period between pulses of the received signal, and determining, based on the interval period, whether or not noise is inputted, and the pulse cycle detection circuit preferably notifies the receiver sensitivity adjustment circuit of a result of the determination regarding the noise input or optimizes a circuit condition of the optical space communication reception circuit, based on the result of the determination regarding the noise input.

A maximum value and a minimum value of the pulse cycle are set in an ordinary communication code and standard. Therefore, according to the above configuration, if the pulse period detecting circuit compares the detected interval period with the set maximum value and minimum value of the pulse cycle, it is possible to detect unwanted noise precisely and easily. Consequently, it is possible to send, to the receiver sensitivity adjustment circuit, the noise detecting result or to optimize the circuit condition based on the result of the detecting noise input.

Besides, the optical space communication reception circuit according to the present invention is preferably arranged such that a pulse cycle detection circuit determines that the noise is inputted, if the interval period is below or equal to 10 usec or above or equal to 1.1 msec.

According the above configuration, it is possible to detect the unwanted noise input suitably, for example, particularly in the communication speed of 9.6 kbps to 115 kbps set in the IrDA communication, the ordinary infrared communication code and standard.

Besides, the optical space communication reception circuit according to the present invention includes a pulse width detection circuit for measuring a pulse width of the received signal, and determining, based on the pulse width, whether or not noise is inputted, and the pulse width detection circuit preferably notifies the receiver sensitivity adjustment circuit of a result of the determination regarding the noise input or optimizes a circuit condition of the optical space communication reception circuit based on the result of determination regarding the noise input.

A maximum value and a minimum value of pulse width are set in an ordinary communication code and standard. Therefore, according to the above configuration, if the pulse width detection circuit compares the detected pulse width with the set maximum value and minimum value of the pulse width, it is possible to detect the unwanted noise both precisely and easily. Consequently, it is possible to send, to the receiver sensitivity adjustment circuit, the result of detecting noise input or to optimize the circuit condition based on the result of judging the noise input.

Besides, the optical space communication reception circuit according to the present invention includes a pulse cycle detection circuit for measuring an interval period between pulses of the received signal, and determining, based on the interval period, whether or not noise is inputted and a pulse width detection circuit for measuring a pulse width of the received signal, and determining, based on the pulse width, whether or not noise is inputted, and the optical space communication reception circuit preferably (i) notifies the receiver sensitivity adjustment circuit of results of the determination if both the pulse cycle detection circuit and the pulse width detection circuit judge that the noise is inputted or (ii) optimizes a circuit condition of the optical space communication reception circuit based on the results of the determination.

According to the above configuration, the pulse cycle detection circuit can detect the unwanted noise based on the interval period between pulses of the received signals while the pulse width detection circuit can detect the unwanted noise based on the pulse width of the received signals. Then, if both the pulse cycle detection circuit and the pulse width detection circuit detect the unwanted noise, the optical space communication reception circuit sends, to the receiver sensitivity adjustment circuit, the result of detecting the noise or optimizes the circuit condition based on the result of detecting the noise. Thus, accuracy of the noise detecting can be enhanced.

Besides, the optical space communication reception circuit according to the present invention includes a communication state detection circuit for detecting a pulse rise period of the received signal, and determining, based on the pulse rise period, whether or not noise is inputted and how much communication speed is, and the receiver sensitivity adjustment circuit preferably adjusts the receiver sensitivity based on results of the determination by the communication state detection circuit, or optimizes a circuit condition of the optical space communication reception circuit based on the results of the determination by the communication state detection circuit.

According to the above configuration, the communication state detection circuit detects the noise input and also the communication speed. Then, the receiver sensitivity adjustment circuit either: adjusts the receiver sensitivity, based on the detection results by the communication state detection circuit, such that the receiver sensitivity can be optimized for the respective communication states; or optimizes the circuit conditions, based on the detection results by the communication state detection circuit, such that the circuit condition can be optimized for the respective communication speed. In addition, it is possible to detect the noise otherwise would not be detected by judging the pulse cycle or pulse width.

Besides, the optical space communication reception circuit according to the present invention is preferably arranged such that the communication state detection circuit includes a first pulse-rise-period detection circuit in which a first judgment-criterion-period is set and which compares the first judgment-criterion-period with the detected pulse rise period and a second pulse-rise-period detection circuit in which a second judgment-criterion-period shorter than the first judgment-criterion-period is set and which compares the second judgment-criterion-period with the detected pulse rise period.

According to the above configuration, since the first pulse rise period detection circuit and the second pulse-rise-period detection circuit are provided, the detected pulse rise period is categorized in any one of the following cases: where the pulse rise period is longer than the first judgment-criterion-period; where the pulse rise period is shorter than the first detection-criterion-period and longer than the second judgment-criterion-period; and where the pulse rise period is shorter than the second judgment-criterion-period.

By this, since the pulse rise period is shorter as the communication speed is faster, it is possible to judge, for example, that the received signal is noise if the pulse rise period is longer than the first judgment-criterion-period; that the received signal is the signal of the first communication speed if the pulse rise period is shorter than the first judgment-criterion-period and longer than the second judgment-criterion-period; and that the received signal is the signal of the second communication speed, which is faster than the first communication speed, if the pulse rise period is shorter than the second judgment-criterion-period.

Besides, the optical space communication reception circuit according to the present invention is preferably arranged such that the first judgment-criterion-period is set in a range between 600 to 700 nsec and the second judgment-criterion-period is set in a range between 40 to 50 nsec.

According to the above configuration, it is possible, for example, to perform the most suitable detection respectively to the communication speed of 9.6 kbps to 115 kbps, to the communication speed greater than 115 kbps, and to the disturbance noise, in the IrDA communication, which is the ordinary infrared communication code and standard.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An optical space communication reception circuit for receiving a signal in switched-over communication speed modes and under settings respectively corresponding to the communication speed modes, wherein:
receiver sensitivity in the respective communication speed modes is set in advance such that maximum communicable distances in the communication speed modes are substantially equal.

2. The optical space communication reception circuit as set forth in claim 1, comprising:
an amplifying stage for amplifying the received signal; and
a waveform shaping outputting stage for shaping a waveform of a signal outputted from the amplifying stage, based on a threshold value,
the setting of the receiver sensitivity carried out by at least one of (i) substantially equalizing maximum gains of the amplifying stage in the respective communication speed modes and (ii) adjusting the threshold value of the waveform shaping outputting stage in the respective communication speed modes.

3. The optical space communication reception circuit as set forth in claim 1, comprising:
an amplifying stage for amplifying the received signal; and
a waveform shaping outputting stage for shaping a waveform of a signal outputted from the amplifying stage, based on a threshold value,
the setting of the receiver sensitivity carried out by at least one of (i) shifting a frequency range of the amplifying stage in the respective communication speed modes and (ii) adjusting the threshold value of the waveform shaping outputting stage in the respective communication speed modes.

4. An optical space communication reception circuit for receiving a signal in switched-over communication speed modes and under settings respectively corresponding to the communication speed modes, comprising:
a receiver sensitivity adjustment circuit for adjusting receiver sensitivity in the respective communication speed modes such that maximum communicable distances in the communication speed modes are substantially equal.

5. The optical space communication reception circuit as set forth in claim 4, comprising:
an amplifying stage for amplifying the received signal; and
a waveform shaping outputting stage for shaping a waveform of a signal outputted from the amplifying stage, based on a threshold value,
the receiver sensitivity adjustment circuit including at least one of (i) a gain control circuit for controlling a maximum gain of the amplifying stage according to one of the communication speed modes in which the optical space communication reception circuit receives the signal, and (ii) a threshold control circuit for controlling a threshold value of the waveform shaping outputting stage according to one of the communication speed modes in which the optical space communication reception circuit receives the signal.

6. The optical space communication reception circuit as set forth in claim 4, comprising:
an amplifying stage for amplifying the received signal; and
a waveform shaping outputting stage for shaping a waveform of a signal outputted from the amplifying stage, based on a threshold value,
the receiver sensitivity adjustment circuit including at least one of (i) a frequency control circuit for controlling a frequency range of the amplifying stage according to one of the communication speed modes in which the optical space communication reception circuit receives the signal, and (ii) a threshold control circuit for controlling the threshold value of the waveform shaping outputting stage according to one of the communication speed modes in which the optical space communication reception circuit receives the signal.

7. The optical space communication reception circuit as set forth in claim 4, wherein the receiver sensitivity adjustment circuit adjusts the receiver sensitivity when noise is inputted.

8. The optical space communication reception circuit as set forth in claim 7, comprising:
a pulse cycle detection circuit for measuring an interval period between pulses of the received signal, and determining, based on the interval period, whether or not noise is inputted,
the pulse cycle detection circuit notifying the receiver sensitivity adjustment circuit of a result of the determination regarding the noise input or optimizing a circuit condition of the optical space communication reception circuit, based on the result of the determination regarding the noise input.

9. The optical space communication reception circuit as set forth in claim 8, wherein the pulse cycle detection circuit determines that noise is inputted, if the interval period is below or equal to 10 usec or above or equal to 1.1 msec.

10. The optical space communication reception circuit as set forth in claim 7, comprising:
a pulse width detection circuit for measuring a pulse width of the received signal, and determining, based on the pulse width, whether or not noise is inputted,
the pulse width detection circuit notifying the receiver sensitivity adjustment circuit of a result of the determination regarding the noise input or optimizing a circuit condition of the optical space communication reception circuit based on the result of determination regarding the noise input.

11. The optical space communication reception circuit as set forth in claim 7, comprising:
a pulse cycle detection circuit for measuring an interval period between pulses of the received signal, and determining, based on the interval period, whether or not noise is inputted; and
a pulse width detection circuit for measuring a pulse width of the received signal, and determining, based on the pulse width, whether or not noise is inputted,
the optical space communication reception circuit (i) notifying the receiver sensitivity adjustment circuit of results of the determination if both the pulse cycle detection circuit and the pulse width detection circuit judge that the noise is inputted, or (ii) optimizing a circuit condition of the optical space communication reception circuit based on the results of the determination.

12. The optical space communication reception circuit as set forth in claim 4, the receiver sensitivity adjustment circuit which, if it is impossible to receive the signal due to noise input, switches over to receiver sensitivity for a communication speed mode selected subsequently to a communication speed mode used when noise is inputted.

13. The optical space communication reception circuit as set forth in claim 4, comprising:
a communication state detection circuit for detecting a pulse rise period of the received signal, and determining, based on the pulse rise period, whether or not noise is inputted and how much communication speed is,
the receiver sensitivity adjustment circuit performing the adjustment based on results of the determination by the communication state detection circuit, or optimizing a circuit condition of the optical space communication reception circuit based on the results of the determination by the communication state detection circuit.

14. The optical space communication reception circuit as set forth in claim 13,
the communication state detection circuit including:
a first pulse-rise-period detection circuit in which a first judgment-criterion-period is set and which compares the first judgment-criterion-period with the detected pulse rise period; and
a second pulse-rise-period detection circuit in which a second judgment-criterion-period shorter than the first judgment-criterion-period is set and which compares the second judgment-criterion-period with the detected pulse rise period.

15. The optical space communication reception circuit as set forth in claim 14, wherein the first judgment-criterion-period is set in a range between 600 to 700 nsec and the second judgment-criterion-period is set in a range between 40 to 50 nsec.

16. An optical space communication reception circuit for receiving a signal in switched-over communication speed modes and under settings respectively corresponding to the communication speed modes, comprising:
a receiver sensitivity adjustment circuit which, if the signal cannot be received due to noise input, switches over to receiver sensitivity for a communication speed mode selected subsequently to a communication speed mode used when noise is inputted or switches a setting of the optical space communication reception circuit to a circuit condition corresponding to a communication speed for the communication speed mode selected subsequently.

17. The optical space communication reception circuit as set forth in claim 16, comprising:
a pulse cycle detection circuit for measuring an interval period between pulses of the received signal, and determining, based on the interval period, whether or not noise is inputted,
the pulse cycle detection circuit notifying the receiver sensitivity adjustment circuit of a result of the determination regarding the noise input or optimizing a circuit condition of the optical space communication reception circuit, based on the result of the determination regarding the noise input.

18. The optical space communication reception circuit as set forth in claim 17, wherein the pulse cycle detection circuit determines that the noise is inputted, if the interval period is below or equal to 10 usec or above or equal to 1.1 msec.

19. The optical space communication reception circuit as set forth in claim 16, comprising:
a pulse width detection circuit for measuring a pulse width of the received signal, and determining, based on the pulse width, whether or not noise is inputted,
the pulse width detection circuit notifying the receiver sensitivity adjustment circuit of a result of the determination regarding the noise input or optimizing a circuit condition of the optical space communication reception circuit based on the result of determination regarding the noise input.

20. The optical space communication reception circuit as set forth in claim 16 comprising:
a pulse cycle detection circuit for measuring an interval period between pulses of the received signal, and determining, based on the interval period, whether or not noise is inputted; and
a pulse width detection circuit for measuring a pulse width of the received signal, and determining, based on the pulse width, whether or not noise is inputted,
the optical space communication reception circuit (i) notifying the receiver sensitivity adjustment circuit of results of the determination if both the pulse cycle detection circuit and the pulse width detection circuit judge that the noise is inputted, or (ii) optimizing a circuit condition of the optical space communication reception circuit based on the results of the determination.

21. An optical space communication device comprising:
an optical space communication reception circuit which includes a light receiving element for receiving a sent light signal in switched-over communication speed modes and under settings respectively corresponding to the communication speed modes; and
an optical space communication transmission circuit which includes a light emitting element for outputting a light signal,
the optical space communication reception circuit being arranged such that receiver sensitivity in the respective communication speed modes is set in advance such that maximum communicable distances in the communication speed modes are substantially equal.

22. An optical space communication system comprising an optical space communication device,
the optical space communication device including:
an optical space communication reception circuit which includes a light receiving element for receiving a sent light signal in switched-over communication speed modes and under settings respectively corresponding to the communication speed modes; and
an optical space communication transmission circuit which includes a light emitting element for outputting a light signal,
the optical space communication reception circuit being arranged such that receiver sensitivity in the respective communication speed modes is set in advance such that maximum communicable distances in the communication speed modes are substantially equal.

23. An optical space communication system comprising an optical space communication reception circuit for receiving a signal in switched-over communication speed modes and under settings respectively corresponding to the communication speed modes,
the optical space communication reception circuit including a receiver sensitivity adjustment circuit which, if the signal cannot be received due to noise input, switches over to receiver sensitivity for a communication speed mode selected subsequently to a communication speed mode used when noise is inputted or switches a setting of the optical space communication reception circuit to a circuit condition corresponding to a communication speed for the communication speed mode selected subsequently.

24. An electronic device comprising an optical space communication device, the optical space communication device including:
an optical space communication reception circuit which includes a light receiving element for receiving a sent light signal in switched-over communication speed modes and under settings respectively corresponding to the communication speed modes; and
an optical space communication transmission circuit which includes a light emitting element for outputting a light signal,
the optical space communication reception circuit being arranged such that receiver sensitivity in the respective communication speed modes is set in advance such that maximum communicable distances in the communication speed modes are substantially equal.
